(19) United States
(12) Patent Application Publication
(10) Pub. No.: US 2025/0017414 A1
(43) Pub. Date: Jan. 16, 2025

(54) BEVERAGE APPLIANCE

(71) Applicant: Breville Pty Limited, Alexandria NSW (AU)

(72) Inventors: Con PSAROLOGOS, Alexandria NSW (AU); Xiang James REN, Alexandria NSW (AU); Lochana Subasekara WIDANAGAMAGE DON, Alexandria NSW (AU); Tae-kyung KONG, Alexandria NSW (AU); Man Ho Kelvin LEE, Alexandria NSW (AU); Giovanni BAEZ ALVAREZ, Alexandria NSW (AU); Vinay KUMAR, Alexandria NSW (AU); Jianqing HU, Alexandria NSW (AU)

(21) Appl. No.: 18/267,897

(22) PCT Filed: Dec. 17, 2021
(86) PCT No.: PCT/AU2021/051514

§ 371 Date: Jun. 16, 2023

(30) Foreign Application Priority Data
Dec. 18, 2020 (AU) 2020904743
Aug. 4, 2021 (AU) 2021902398

(51) Int. Cl. A47J 31/52; A47J 31/60

(52) U.S. Cl. CPC A47J 31/525; A47J 31/60

(57) ABSTRACT

An appliance for making a beverage. The appliance comprises at least one beverage making component configured to receive liquid for making the beverage using liquid and a liquid flow path in fluid communication with and configured to provide the liquid to the at least one beverage making component. The liquid flow path comprises an inlet configured to receive untreated liquid, the inlet comprising a first sensor assembly configured to generate a first electrical signal indicative of a degree of purity of the untreated liquid, a filter assembly positioned between the inlet and the at least one beverage making component and configured to filter the untreated liquid, and a second sensor assembly positioned between the filter assembly and the at least one beverage making component to generate a second electrical signal indicative of a degree of purity of the treated liquid. The appliance also comprises a controller coupled with the first sensor assembly and the second sensor assembly and configured to monitor performance of the filter assembly based on the first electrical signal and the second electrical signal.

### FIELD

The present invention relates generally to an appliance for making a beverage and a method for controlling thereof.

### BACKGROUND

An appliance for making a beverage, such as an espresso coffee machine, typically uses liquid, such as water, for making a beverage. Quality of the liquid provided to the appliance can vary based on chemical composition of the liquid. For example, chemical composition of water supplied to the appliance can vary depending on various factors, for example, age of water pipes used to supply water, whether the supplied water is provided from underground sources or from rain fall.

To ensure acceptable quality of the liquid used for making a beverage and prolong useful life of the appliance, the appliance may include a filter for filtering ions of minerals, such as calcium and/or magnesium, from the liquid before the liquid is used for making the beverage. By filtering out ions of minerals, which otherwise may build up on internal components of the appliance, the filtering reduces risks of faults of the internal components of the appliance.

The filter periodically requires replacement to maintain quality of filtering and reduce risks of bacteria and/or mold growth. When exactly replacement is required typically depends on a configuration of the filter and quality of the liquid being filtered which is largely unknown. Consequently, a user of the appliance may be unaware that components of the filter require replacement, thereby increasing the risk of minerals building up on the internal components of the appliance.

Additionally, periodic descaling may be required. However, some users choose to bypass descaling and, consequently, ions of minerals built up on the internal components of the appliance may cause damage and shorten the useful life of the appliance. Accordingly, a need exists for automatically controlling the appliance to prolong its useful life.

### SUMMARY OF INVENTION

It is an object of the present invention to substantially overcome, or at least ameliorate, one or more disadvantages of existing arrangements, or provide a useful alternative.

In accordance with one aspect of the present disclosure, there is provided an appliance for making a beverage, the appliance comprising: at least one beverage making component configured to receive liquid for making the beverage using liquid; a liquid flow path in fluid communication with and configured to provide the liquid to the at least one beverage making component, the liquid flow path comprising: an inlet configured to receive untreated liquid, the inlet comprising a first sensor assembly configured to generate a first electrical signal indicative of a degree of purity of the untreated liquid, a filter assembly positioned between the inlet and the at least one beverage making component and configured to filter the untreated liquid; and a second sensor assembly positioned between the filter assembly and the at least one beverage making component to generate a second electrical signal indicative of a degree of purity of the treaded liquid; and a controller coupled with the first sensor assembly and the second sensor assembly and configured to monitor a performance of the filter assembly based on the first electrical signal and the second electrical signal.

The controller may be further configured to determine an electrical conductivity of the untreated liquid based on the first electrical signal and determine an electrical conductivity of the treated liquid from the filter assembly based on the second electrical signal.

Each of the first sensor assembly and the second sensor assembly may preferably comprise a first electrode and a second electrode, the first electrode and the second electrode being spaced apart from each other. The controller is preferably configured to cause the first electrode to have a higher electrical potential than the second electrode for a first set of one or more cycles and cause the second electrode to have a higher electrical potential than the first electrode for a second set of one or more cycles. The first electrode and the second electrode of each sensor assembly may be configured to be alternately powered by the controller such that one of the electrodes receives voltage from the controller and the other electrode is grounded. The controller is preferably configured to reverse polarity of the electrodes after one or more cycles of determining the electrical conductivity.

The first electrical signal may be detected at the first electrode of the first sensor assembly, and the second electrical signal may be detected at the first electrode of the second sensor assembly. The first electrical signal may correspond to a voltage across the first and second electrodes of the first sensor assembly and the second electrical signal may correspond to a voltage detected across the first and second electrodes of the second sensor assembly.

The controller is preferably further configured to: determine the electrical conductivity of the untreated liquid based on the voltage detected by the first sensor assembly and a configuration of the first electrode and the second electrode of the first sensor assembly; and determine the electrical conductivity of the treated liquid based on the voltage detected by the second sensor assembly and a configuration of the first and the second electrode of the second sensor assembly. The configuration of the electrodes may comprise at least one of shape of the electrodes, dimensions of the electrodes, and distance between the electrodes.

The liquid flow path may further comprise at least one temperature sensor assembly coupled with the controller. The controller may be further configured to determine a temperature of the liquid before and/or after being treated by the filter assembly.

The controller may be configured to: determine an electrical conductivity of the untreated liquid based on the first electrical signal and the temperature of the liquid; and determine an electrical conductivity of the treated liquid based on the second electrical signal and the temperature of the liquid.

Each of the first sensor assembly and the second sensor assembly may comprise an induction sensor comprising a first coil spaced apart from a second coil, wherein the first coil induces an electrical current in the second coil when the first coil is powered by the controller; and wherein the controller is further configured to determine the degree of purity of the liquid based on the induced electrical current in the second coil.

The controller may be further configured to: determine performance of the filter assembly if the electrical conductivity of the untreated liquid is below a conductivity threshold; and bypass the process of determining the performance of the filter assembly if the electrical conductivity of the untreated liquid is above the conductivity threshold. The controller may be configured to determine the performance of the filter assembly based on a difference between the electrical conductivity of the treated liquid and the electrical conductivity of the untreated liquid. The controller may be configured to determine the performance of the filter assembly by comparing the difference with a threshold. The controller may be further configured to determine a life expectancy of the filter assembly based on a plurality of electrical conductivity values recorded for the untreated liquid and a plurality of corresponding electrical conductivity values recorded for the treated liquid.

The first sensor assembly may be positioned at least partially within a tank of the appliance and the second sensor assembly may be an inline sensor assembly. The inline sensor assembly may comprise a temperature sensor assembly.

In accordance with another aspect of the present disclosure, there is provided a method of controlling an appliance for making a beverage having at least one beverage making component using liquid for making the beverage, a liquid flow path integrally formed with and providing the liquid to the at least one beverage making component and a filter assembly configured for the appliance and filtering the liquid in the liquid flow path, the method comprising: determining a first electrical signal indicative of electrical conductivity of untreated liquid in the liquid flow path; determining a second electrical signal indicative of electrical conductivity of treated liquid in the liquid flow path, the treated liquid being provided to the at least one beverage making component; and monitoring performance of the filter assembly based on the first electrical signal and the second electrical signal.

The method may further include determining an electrical conductivity of the untreated liquid based on the first electrical signal and a configuration of a sensor assembly generating the first electrical signal; and determining an electrical conductivity of the treated liquid based on the second electrical signal and a configuration of a sensor assembly generating the second electrical signal. The method may further include determining the electrical conductivity based on temperature of the liquid in the liquid flow path.

The method may further include determining a performance of the filter assembly if the electrical conductivity of the untreated liquid is above a conductivity threshold; and bypassing the process of determining the performance of the filter assembly if the electrical conductivity of the untreated liquid is below the conductivity threshold.

The method may further include determining the performance of the filter assembly based on a difference between the electrical conductivity of the treated liquid and the electrical conductivity of the untreated liquid. The method may include comparing the difference with a threshold. The method may further include determining a life expectancy of the filter assembly based on a plurality of electrical conductivity values recorded for the untreated liquid and a plurality of corresponding electrical conductivity values recorded for the treated liquid.

In accordance with a further aspect of the present invention, there is provided a method of controlling descaling of an appliance using a descaling agent, the method comprising: determining a first ionic content value indicative of ionic content of liquid in at least one receptacle of the appliance; determining whether the appliance is in a descaling mode; determining a type of the liquid using the determined first ionic content value based on determining that the appliance is in a descaling mode; and controlling descaling of the appliance based on the determined type of the liquid.

The first ionic content value may correspond to at least one of an electrical conductivity value and a magnetic permeability value.

The step of controlling may further comprise selecting one of a plurality of descaling settings of the appliance in response to the first ionic content value, each setting of the plurality of descaling settings comprising a respective duration of carrying out descaling and a respective temperature during descaling. The method preferably includes increasing the temperature during descaling and/or increasing duration of descaling. The method preferably includes decreasing the temperature during descaling and/or decreasing duration of descaling.

The step of controlling may further comprise causing the appliance to indicate to a user to adjust the descaling agent in response to the determined first ionic content value. For example, the step of controlling may further comprise causing the appliance to indicate to a user to dilute or add more the descaling agent in response to the determined first ionic content value.

The step of controlling may further comprise determining a further ionic content value indicative of ionic content of liquid in the appliance; and determine whether descaling of the appliance has been completed based on the further ionic content value. The further ionic content value may be determined on the liquid in the at least one receptacle, wherein the first and further ionic content values are determined at different times. The further ionic content value may be determined in at least one further receptacle of the appliance.

In accordance with another aspect of the present invention, there is provided an appliance for making a beverage, the appliance comprising: at least one receptacle configured to receive liquid; a sensor assembly configured to generate an electrical signal indicative of ionic content of the liquid in the receptacle; and a controller coupled with the sensor assembly and configured to control descaling of the appliance, wherein the controller is configured to: determine a first ionic content value indicative of ionic content of the liquid in the at least one receptacle of the appliance based on the generated electrical signal; determine whether the appliance is in a descaling mode; in response to determining that the appliance is in the descaling mode, determine a type of a descaling agent based on the determined first ionic content value; and control descaling of the appliance based on the determined type of the liquid.

The first ionic content value may correspond to at least one of an electrical conductivity value and a magnetic permeability value.

The controller may be configured to select one of a plurality of descaling settings of the appliance in response to the first ionic content value, each setting of the plurality of descaling settings comprising a respective duration of carrying out descaling and temperature during descaling.

The controller may be further configured to increase at least one of the temperature during descaling and the duration of descaling. The controller may be configured to decrease at least one of the temperature during descaling and the duration of descaling.

The appliance may further comprise a user interface, wherein the controller is further configured to cause the user interface to provide an indication to the user to adjust the descaling agent in response to a detected concentration of the descaling agent. For example, the controller may be configured to provide an indication to the user to dilute the descaling agent in response to a high concentration of descaling agent being detected; and to provide an indication to the user to add more descaling agent in response to a low concentration of descaling agent being detected.

The controller may be further configured to determine a further ionic content value indicative of ionic content of liquid in the appliance; and determine whether descaling of the appliance has been completed based on the further ionic content value. The controller may be configured to determine further ionic content value in the receptacle, wherein the first and further ionic content values are determined by the controller at different times. The controller may be configured to determine the further ionic content value in at least one further receptacle of the appliance.

In accordance with a further aspect of the present invention, there is provided a method of controlling an appliance for making a beverage, the method comprising: determining a first ionic content value indicative of ionic content of liquid in at least one receptacle of the appliance; determining a class of the liquid based on the determined first ionic content value, the class being determined from a plurality of classes comprising an impure liquid class, a pure liquid class and a descaling agent class; controlling the appliance based on the determined class of the liquid.

The class of descaling agent may include a plurality of subclasses such as a low concentration descaling agent subclass, a normal concentration descaling agent subclass, and a high concentration descaling agent subclass.

The appliance preferably includes a user interface and a filter assembly. The step of controlling may comprise causing the user interface of the appliance to indicate to a user to remove at least a portion of a filter assembly if the determined class of the liquid is the descaling agent class.

The step of controlling may further include determining whether at least a portion of the filter assembly of the appliance is to be replaced based on at least the first ionic content value; and causing the user interface of the appliance to indicate to a user that the at least a portion of filter assembly is to be replaced in response to the first ionic content value. The method may include determining whether the at least a portion of the filter assembly of the appliance is to be replaced by comparing the first ionic content value with a first threshold. For example, the method may cause the user interface to indicate to the user to replace the at least a portion of the filter assembly if the first ionic content value is above the first threshold. The method may include determining a second ionic content value based on an electrical signal from a sensor assembly located downstream of the filter assembly; comparing the second ionic content value with the first ionic content value; and determining if the at least a portion of the filter assembly is to be replaced based on the comparison between the second ionic content value and the first ionic content value.

The liquid may be determined to be of the pure liquid class if the first ionic content value is below the first threshold. The liquid may be determined to be of the impure liquid class if the first ionic content value is above the first threshold and below a second threshold. The liquid may be determined to be of the descaling agent class if the first ionic content value is above the second threshold.

The step of controlling may comprise adjusting a descaling profile of the appliance based on the first ionic content value if the liquid is determined to be of the descaling agent class. The step of controlling may comprise adjusting at least one of temperature and duration associated with the descaling profile proportionate to the first ionic content value in response to determining that the liquid is a descaling agent.

In accordance with another aspect of the present invention, there is provided an appliance for making a beverage having a controller configured to perform the method of the above aspect.

Other aspects are also disclosed.

### BRIEF DESCRIPTION OF DRAWINGS

Example embodiments should become apparent from the following description, which is given by way of example only, of at least one preferred but non-limiting embodiment, described in connection with the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 is a schematic diagram of an appliance for making a beverage in accordance with an embodiment of the present disclosure.

FIG. 2 is a schematic diagram of the physical components used for monitoring performance of a filter assembly of the appliance for making a beverage in accordance with an embodiment of the present disclosure.

FIGS. 3A and 3B collectively form a schematic block diagram of a controller for monitoring performance of the filter assembly.

FIG. 4 is a schematic diagram of a sensor assembly for sensing an electrical signal indicative of electrical conductivity of liquid.

FIG. 5 is a schematic diagram of a temperature sensor for sensing an electrical signal indicating temperature of the liquid.

FIG. 6 is a schematic diagram of an electronic circuit of the sensor assembly of FIG. 4.

FIG. 7 is an embodiment of taking measurements of voltage at the sensor assembly based on time.

FIG. 8 is an embodiment of taking measurements of voltage at the sensor assembly based on gradient.

FIG. 9 is a flow chart showing operation of the controller.

FIG. 10 is a flow chart illustrating operation of step 930 of FIG. 9.

FIG. 11 is a flow chart illustrating operation of the controller to determine remaining life span of the filter assembly.

FIG. 12 is a flow chart showing steps of determining electrical conductivity of the liquid used in steps 910 and 920 of FIG. 9.

FIG. 13 is a schematic diagram of an induction sensor in accordance with an alternative embodiment of the present disclosure.

FIG. 14 is a schematic diagram of a dual compartment tank in accordance with one implementation of the present disclosure.

FIGS. 15A and 15B show perspective views of a removable tank in accordance with one implementation of the present disclosure.

FIG. 16 shows a physical layout of the controller and the sensor assembly in accordance with one implementation of the present disclosure.

FIG. 17 shows a physical layout of the controller and the sensor assembly in accordance with another implementation of the present disclosure.

FIG. 18 shows a method of controlling the appliance in accordance with one implementation of the present disclosure.

FIG. 19 is a flow chart of controlling a descaling process in accordance with one implementation of the present disclosure.

FIG. 20 shows a method of determining if descaling has completed in accordance with one implementation of the present disclosure.

FIG. 21 depicts example electrical conductivity values observed for different liquid types.

FIG. 22 shows comparison of electrical conductivity values of lower and higher hardness drinking water and different concentrations of a descaling agent.

FIG. 23 shows an example configuration of the tank and the appliance in accordance with one implementation of the present disclosure.

FIGS. 24A and 24B show a front perspective view of a probe assembly and an exploded front perspective view respectively of the probe assembly in accordance with one implementation of the present disclosure.

FIGS. 25A and 25B show a bottom perspective view of the probe assembly an exploded bottom perspective view respectively of the probe assembly in accordance with one implementation of the present disclosure.

FIGS. 26A and 26B show a front perspective view and an exploded front perspective view respectively of a pogo pin assembly in accordance with one implementation of the present disclosure.

FIGS. 27A and 27B show a bottom perspective view and an exploded bottom perspective view of the pogo pin assembly in accordance with one implementation of the present disclosure.

FIG. 28A shows an enlarged view of the pogo pin assembly mounted within the supporting base portion in accordance with one implementation of the present disclosure.

FIG. 28B shows an enlarged view of the probe assembly mounted onto the pogo pin assembly collectively forming a first sensor assembly in accordance with one implementation of the present disclosure.

FIG. 29A shows an enlarged perspective view of the first sensor assembly formed by the probe assembly and the pogo pin assembly mounted at a bottom portion of the tank in accordance with one implementation of the present disclosure.

FIG. 29B shows a perspective view of the first sensor assembly formed by the probe assembly and the pogo pin assembly in accordance with one implementation of the present disclosure.

FIG. 29C shows a sectional view of the first sensor assembly formed by the probe assembly and the pogo pin assembly in accordance with one implementation of the present disclosure.

FIG. 30A shows an enlarged perspective view of the probe assembly positioned within the tank in accordance with one implementation of the present disclosure.

FIG. 30B shows an enlarged perspective view of the pogo pin assembly with a protective cap in accordance with one implementation of the present disclosure.

FIGS. 31A, 32A and 33A show a right perspective view, a left perspective view and a rear perspective view respectively of a second sensor assembly in accordance with one implementation of the present disclosure.

FIGS. 31B, 32B and 33B show an exploded right perspective view, an exploded left perspective view and an exploded rear perspective view respectively of the second sensor assembly in accordance with one implementation of the present disclosure.

### DESCRIPTION OF EMBODIMENTS

The present disclosure relates to an appliance 100 for making a beverage, for example, an espresso coffee machine. While the following disclosure is provided with references to an espresso coffee machine, the disclosure is not limited to the espresso coffee machine and may be applicable to other appliances for making a beverage, for example, a drip filter coffee machine, a tea maker or a carbonated water maker.

The appliance 100 may heat the liquid to make a beverage, such as coffee. The appliance 100 may include at least one beverage-making component also referred to herein as “a beverage making component”. The beverage making component comprises, for example, a pump 108 or a heater 110, configured to receive liquid for making the beverage. The appliance 100 may also include a liquid flow path in fluid communication with and configured to provide the liquid to the at least one beverage making component. The appliance 100 also includes a controller 260 configured to control the appliance 100. In some implementations, the controller may monitor performance of a filter assembly 106 installed within the liquid flow path. In alternative implementations, the controller may control descaling of the appliance 100.

The liquid flow path may comprise an inlet, such as a built-in or removable tank 102 for holding the liquid 104, configured to receive untreated liquid, a pre-treatment sensor assembly 109 (referred to “a first sensor assembly” hereinafter), a filter assembly 106 and a post-treatment sensor assembly 111 (referred to “a second sensor assembly” hereinafter). As described below, in some implementations, the liquid flow path may comprise only one sensor assembly. The sensor assemblies 109 and 111 may be configured to detect ionic content of the liquid. The ionic content can be used as an indication of liquid properties, such as purity and/or acidity. The ionic content can be detected either as an electrical conductivity signal or as a magnetic permeability signal (discussed below).

The filter assembly 106 can be integrally formed within the appliance 100 and positioned within the liquid flow path between the inlet and the at least one beverage making component. The filter assembly 106 is configured to filter the untreated liquid. In a preferred implementation, the filter assembly 106 is positioned between the tank 102 and the pump 108.

Both the first sensor assembly 109 and the second sensor assembly 111 can be integrally formed within the components of the appliance 100 and are coupled with the controller 260. The first sensor assembly 109 is configured to sample the untreated liquid and generate a first electrical signal indicative of ionic content of the untreated liquid, e.g. a degree of purity and/or acidity of the untreated liquid. In some implementations, the first electrical signal corresponds to electrical conductivity of the untreated liquid. In alternative implementations, the first electrical signal corresponds to permeability of the untreated liquid. Electrical conductivity and permeability are considered to be measures of ionic content of the liquid, such as the degree of purity and/or acidity of the liquid.

The second sensor assembly 111 is positioned within the liquid flow path between the filter assembly 106 and the at least one beverage making component, for example the pump 108, to sample the treated liquid, e.g. the filtered liquid, and generate a second electrical signal indicative of ionic content of the treated liquid, e.g. a degree of purity and/or acidity of the treated liquid. In some implementations, the second electrical signal corresponds to electrical conductivity of the treated liquid. In alternative implementations, the second electrical signal corresponds to permeability of the treated liquid.

The controller 260 is operatively coupled with at least one of the first sensor assembly 109 and the second sensor assembly 111. The controller 260 is configured to determine a first ionic content value indicative of ionic content of liquid in at least one receptacle of the appliance 100 using one or both of the sensor assemblies 109 and 111. The receptacle may be, for example, the tank 102 or a conduit of the liquid flow path.

The controller 260 is further configured to determine a class or a type of the liquid based on the determined first ionic content value. The class or type of the liquid may be determined from a plurality of classes such as impure liquid, i.e. “an impure liquid class”, pure liquid, i.e. “a pure liquid class”, and a descaling agent, i.e. “a descaling agent class”, based on the first ionic content value. The descaling agent can be further classified as a low concentration descaling agent, normal concentration, and a high concentration descaling agent based on the first ionic content value.

The controller 260 may be also configured to determine that the liquid is pure if the first ionic content value is below a first threshold, determine that the liquid is impure if the first ionic content value is above the first threshold and below a second threshold, determine that the liquid is a descaling agent if the first ionic content value is above the second threshold. The descaling agent can be further classified as a low concentration descaling agent if the ionic content value is below a third threshold, and classified as a high concentration descaling agent if the first ionic content value is above the third threshold.

Experiments indicate that ionic content values of different liquid types vary. Example measured electrical conductivity values for different liquid classes are shown below in Table 1.

TABLE 1
Example conductivity values for different liquids

| Liquid type | Conductivity (μS/cm) |
|---|---|
| Totally pure water | 0.055 |
| Typical deionized water | 0.1 |
| Distilled water | 0.5-3.0 |
| Reverse osmosis water | 50-100 |
| Domestic “tap” water | 500-800 |
| Potable water | 1,055 max |
| Sea water | 56,000 |
| Brackish water | 100,000 |

As shown in Table 1, the conductivity of tap water is at about 200 μS/cm and the conductivity of pure water is about 0.055 μS/cm. Accordingly, in some implementations, the first threshold can be about 1 μS/cm, the second threshold can be about 1000 μS/cm and the third threshold can be about 2000 μS/cm.

The controller 260 is configured to control the appliance 100 based on the determined class of the liquid. Controlling the appliance may include causing a user interface of the appliance 100, such as a display screen (not shown), to indicate to a user to remove at least a portion of the filter assembly 106 if the liquid is determined to be the descaling agent. Additionally or alternatively, controlling may involve determining, based on at least the first ionic content value, whether at least a portion of a filter assembly of the appliance is to be replaced. The controller 260 may cause the user interface of the appliance 100 to indicate to the user that the at least a portion of the filter assembly 106 is to be replaced in response to determining that the at least a portion of the filter assembly 106 needs to be replaced.

The controller 260 may be further configured to compare the first ionic content value with the first threshold. If the first ionic content value is above the first threshold, the controller 260 may determine a second ionic content value based on an electrical signal from the second sensor assembly 111 and compare the second ionic content value with the first ionic content value. The controller 260 may determine if the at least a portion of the filter assembly is to be replaced based on the comparison.

Controlling the appliance 100 may also comprise adjusting a descaling profile of the appliance 100 based on the first ionic content value if the liquid is determined to be a descaling agent. Adjusting the descaling profile may involve increasing at least one of temperature and duration associated with the descaling profile in response to determining that the liquid is a low concentration descaling agent. Adjusting of the descaling profile may also involve decreasing at least one of temperature and duration associated with the descaling profile in response to determining that the liquid is a high concentration descaling agent. Additionally or alternatively, the controller 260 may cause the user interface of the appliance 260 to indicate to the user to dilute the liquid if the liquid is determined to be a high concentration descaling agent, or add more descaling agent if the liquid is determined to be a low concentration descaling agent.

In some implementations, the controller 260 may be configured to monitor performance of the filter assembly based on the first electrical signal and the second electrical signal. In some implementations, the controller 260 may determine electrical conductivity or the degree of purity of the untreated liquid based on the first electrical signal and determine electrical conductivity or the degree of purity of the treated liquid based on the second electrical signal. In alternative implementations, the degree of purity of the untreated and treated liquid is determined based on respective measurements of permeability generated by corresponding induction sensors. If the degree of purity, e.g. the electrical conductivity or permeability, of the untreated liquid is above a first threshold, the controller 260 may further determine performance of the filter assembly 106 by comparing a difference between the degree of purity, e.g. the electrical conductivity or permeability, of the untreated liquid and the degree of purity, i.e. the electrical conductivity or permeability, of the treated liquid with a second threshold. In some implementations, the controller 260 bypasses the process of determining the performance of the filter assembly 106 if the degree of purity, i.e. the electrical conductivity or permeability, of the untreated liquid is below the first threshold, i.e. the untreated liquid is considered pure.

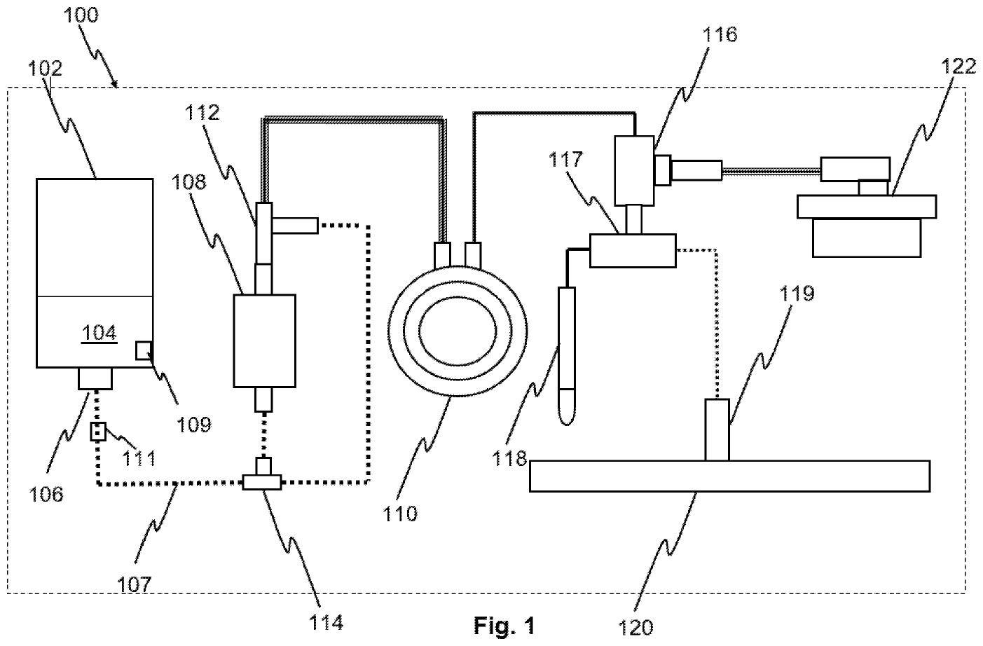

Components of the appliance 100 for making a beverage will described in more detail below with reference to FIG. 1.

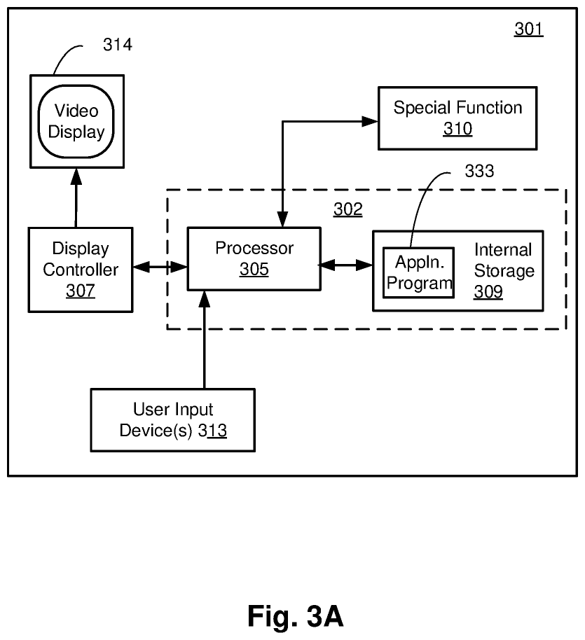

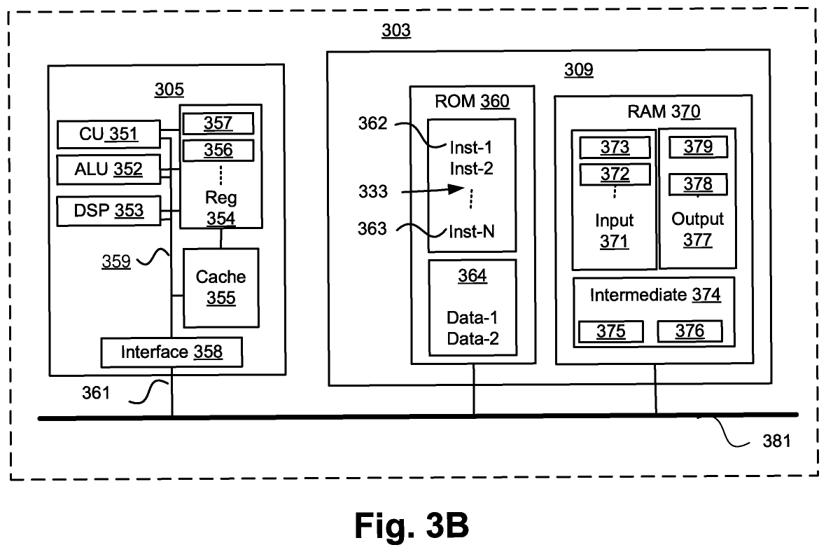

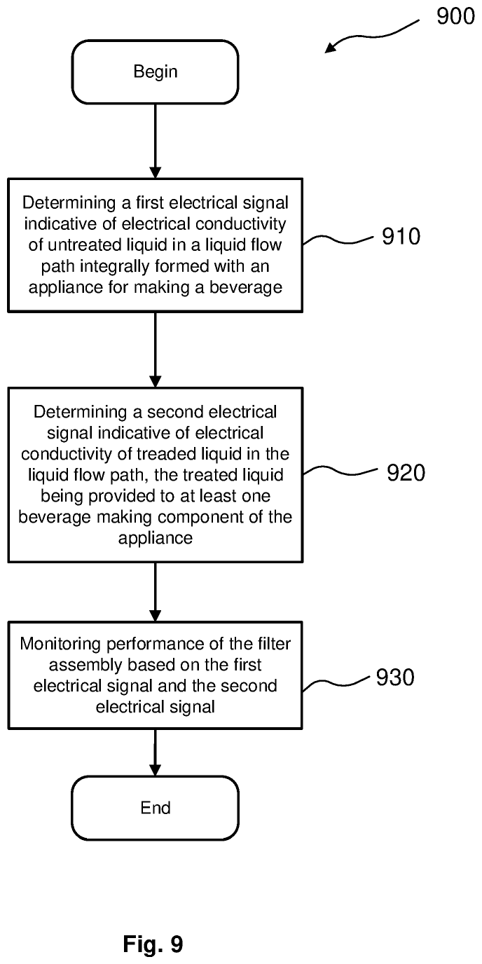

Structural aspects of the controller 260 are described below with references to FIGS. 3A and 3B. Processes executed by the controller 260 are described in more detail below with references to FIGS. 9 to 12.

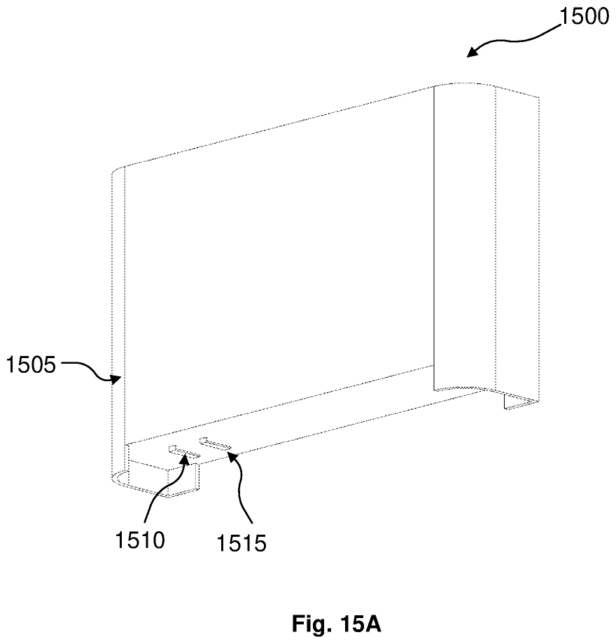

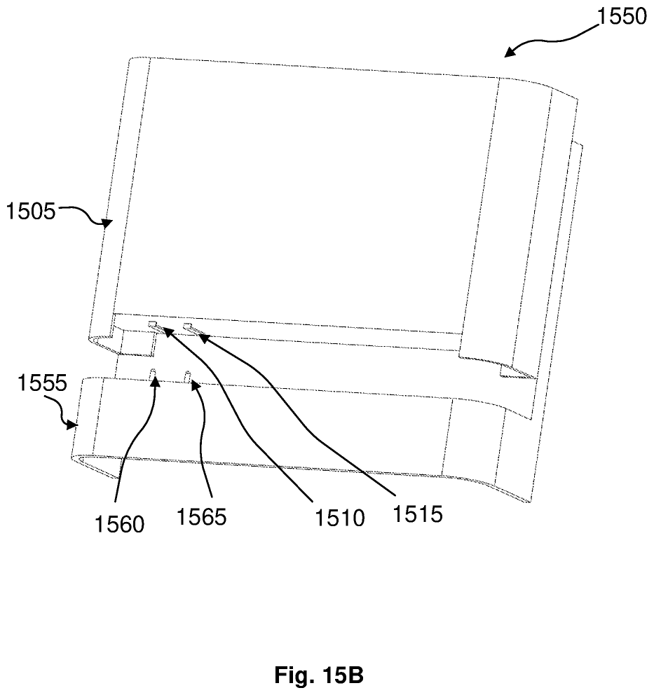

FIG. 1 shows a schematic diagram of the appliance 100 upon which the herein described processes of the present disclosure can be implemented. The appliance 100 includes a water tank 102 to hold a water source 104 for providing water. The water source 104 is filtered in the water tank 102 using a filter assembly 106 configured for the appliance 100 and/or components of the appliance 100, for example, the filter assembly 106 may be integrated within a removable water tank 102 of the appliance 100. The water tank 102 can be removable or integrally formed within the appliance 102. A removable water tank in accordance with some implementations of the present disclosure is discussed in more detail with references to FIGS. 15A and 15B. The water tank 102 includes a first sensor assembly 109 for generating a first electrical signal indicative of electrical conductivity of the water source 102 prior to being filtered, i.e. untreated water.

The output of the water tank 102 is conveyed to a pump 108 using a conduit 107. The conduit 107 includes a second sensor assembly 111 for generating a second electrical signal indicative of electrical conductivity of the water source 102 after being filtered, i.e. treated water, and before being supplied to downstream components of the appliance 100, such as the pump 108. The pump 108 supplies a heater 110 with the water.

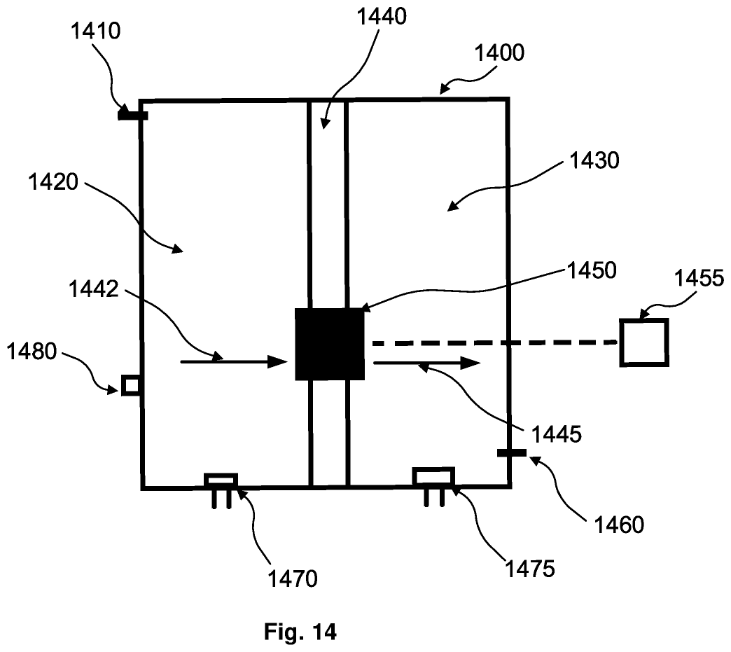

In some implementations, the water tank 102 may have two separate compartments or chambers as discussed in more detail with references to FIG. 14. The first compartment may be configured to receive the untreated liquid, such as water. The first compartment may have the first sensor assembly 109 coupled with or attached to a wall of the first compartment for measuring the first electrical signal indicative of the degree of water purity. The second compartment may be configured to receive the treated liquid, i.e. the liquid after being treated by the filter assembly 106. The second compartment may have the second sensor assembly 111 coupled with or attached to a wall of the second sensor assembly 111 for measuring the second electrical signal indicative of the degree of water purity. The first compartment may be separated from the second compartment by at least one wall with the filter assembly 106 disposed between the compartments such that the first compartment is in liquid communication with the second compartment via the filter assembly 106. For example, when the pump 108 is powered on, the water may flow from the first compartment via the filter assembly 106 to the second compartment and the pump 108.

The appliance 100 also includes the controller 260 (not shown in FIG. 1, but shown in later figures), which controls the appliance 100. In some implementations, the controller 260 may monitor performance of the filter assembly 106 based on the first electrical signal and the second electrical signal. For example, the controller 260 may send a signal to a user interface system of the appliance 100, such as a display screen, indicating that a portion or the entire filter assembly 106 requires replacement and cause the display screen to display that at least the portion of the filter assembly 106 requires replacement. The portion of a filter assembly to be replaced could be a filter portion of the filter assembly. Alternatively, the filter assembly may comprising a plurality of filter units and a portion of the filter assembly to be replaced could be one or more of the plurality of filter units. Additionally, or alternatively, the controller 260 may determine a remaining life span of the filter assembly 106, send a signal to the user interface system indicating the determined remaining life span and cause the display screen to display the remaining life span.

In some implementations, the heater 110 is a liquid flow through heater. The output of the pump 108 may be regulated by an over pressure valve (OPV) 112 which returns excess pump pressure or flow to the inlet of the pump 108 by way of a T-joint 114 which conveys both the flow of water from the water tank 102 and the excess flow from the OPV 112 to the inlet of the pump 108. The OPV 112 is typically set to 10 bar. The conduits between the water tank 102, the T-joint 114 and the inlet of the pump 108 are typically in the form of silicone tubing secured at either end with ties, whilst the conduit between the outlet of the pump 108 and the inlet of the heater 110 is typically in the form of braided silicone tubing secured at either end with O-clips. The output of the heater 110 is preferably regulated by a 3/2 solenoid output control valve (SOV) 116. The heated water that leaves the output of the heater 110 is preferably conveyed to the SOV 116 by polytetrafluoroethylene (PTFE) tubing secured at either end with U-clips. When the SOV 116 is energised, the output of the heater 110 is regulated by a steam OPV 117 which directs the output to discharge via a discharge line (preferably formed of PTFE) into a steam wand 118 of the appliance 100 or is open to atmospheric overflow. The atmospheric overflow is preferably conveyed by silicone tubing to a purge connector 119 and into a drip tray 120 of the appliance 100. When the SOV 116 is de-energised, the output of the heater 110 is open to a shower head 122 of the appliance 100. The output of the heater 110 is preferably conveyed from the SOV 116 to the shower head 122 by braided silicone tubing.

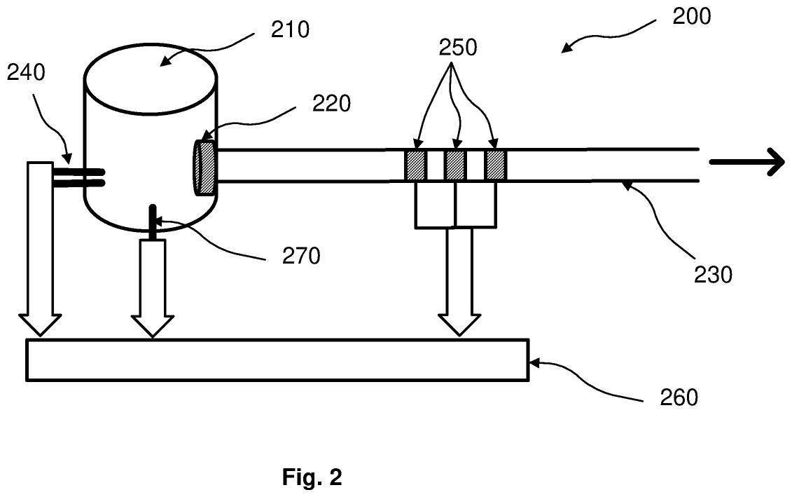

FIG. 2 shows the liquid flow path (or hydraulic line) in accordance with the present disclosure in more detail. The liquid flow path 200 includes the inlet such as a tank 210 and a conduit 230 supplying the liquid to the at least one beverage making components of the appliance 100. The tank 210 may include a filter assembly 220 and a first sensor assembly 240. The first sensor assembly 240 is configured to sense a first electrical signal indicating ionic content or, in this instance, a degree of purity of untreated liquid in the tank 210 and send the first electrical signal to the controller 260.

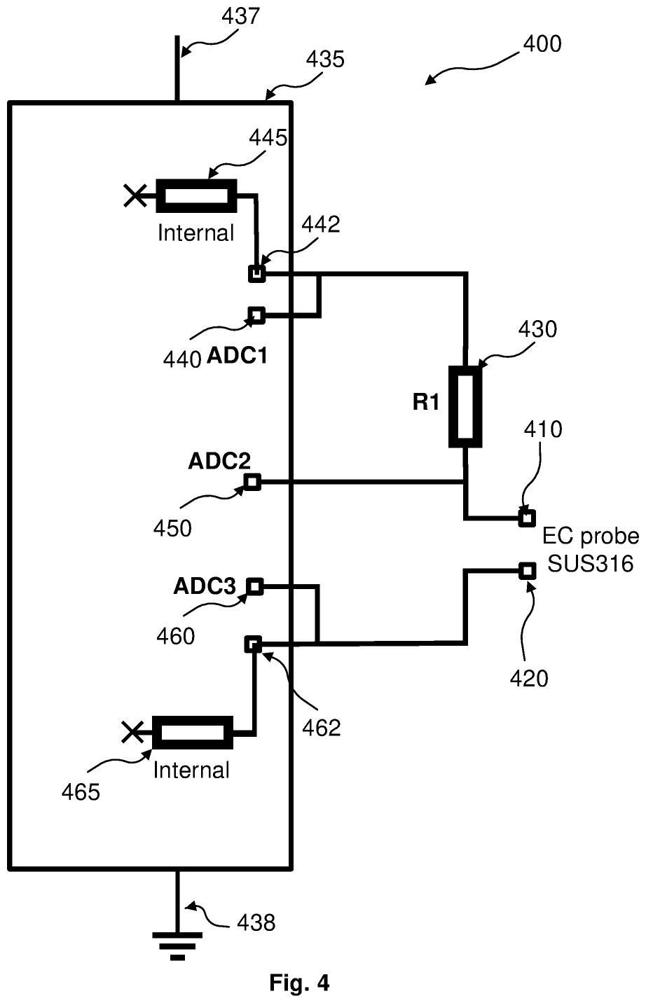

The conduit 230 includes a second sensor assembly 250 in liquid communication with the filter 220 and the at least one beverage making component. The second sensor assembly is configured to sense a second electrical signal indicating ionic content or, in this instance, a degree of purity of treated liquid in the conduit 250 and send the second electrical signal to the controller 260. The first sensor assembly 240 and the second sensor assembly 250 may have similar configuration which is discussed in more detail with references to FIG. 4.

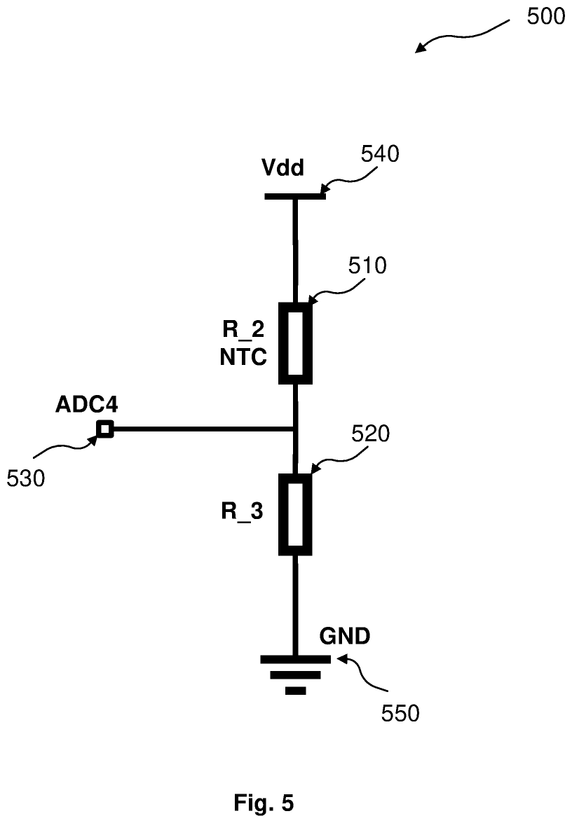

The tank 210 may include a temperature sensor 270 configured to generate an electrical signal indicative of a sensed temperature of the liquid (before or after treatment) in the tank 210 and send that signal to the controller 260. The sensor 270 is preferably a thermistor 270 shown in more detail in FIG. 5. The temperature sensor 270 may be mounted anywhere in the water flow path within the appliance before the temperature of the liquid is altered, for example, by the heater 110. In a preferred implementation, the temperature sensor 270 can be mounted in the tube 230 near the second sensor assembly 250. Mounting the temperature sensor 270 in tube 230 in proximity to the second sensor assembly 250 is particularly advantageous in terms of usability and manufacturability.

The temperature detected by the temperature sensor 270 is used to calibrate the first and second electrical signals and accurately determine electrical conductivity and/or magnetic permeability. In some implementations, one temperature sensor 270 can be placed in the tank 210 to sense water temperature in the tank 210 and/or an inline temperature sensor 270 can be placed in the liquid flow path after the filter assembly 220 to sense the water temperature after filter assembly 220. If two temperature sensors are used, the electrical conductivity of the untreated liquid can be determined using data from the temperature sensor 270 in the tank 210 and the electrical conductivity of the treated liquid can be determined using data from the inline temperature sensor 270 in the liquid flow path after the filter assembly 220.

In alternative implementations, data from either one of the temperature sensor 270 in the tank 210 or the inline temperature sensor 270 in the liquid flow path after the filter assembly 220 is used to determine the electrical conductivity of both treated and untreated liquid.

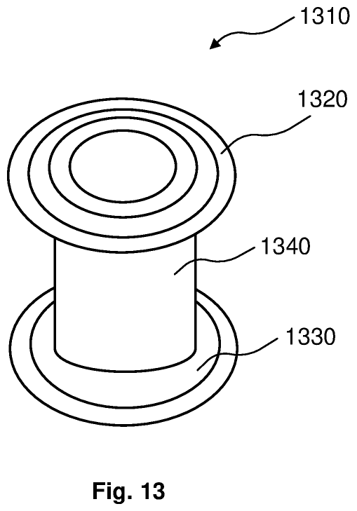

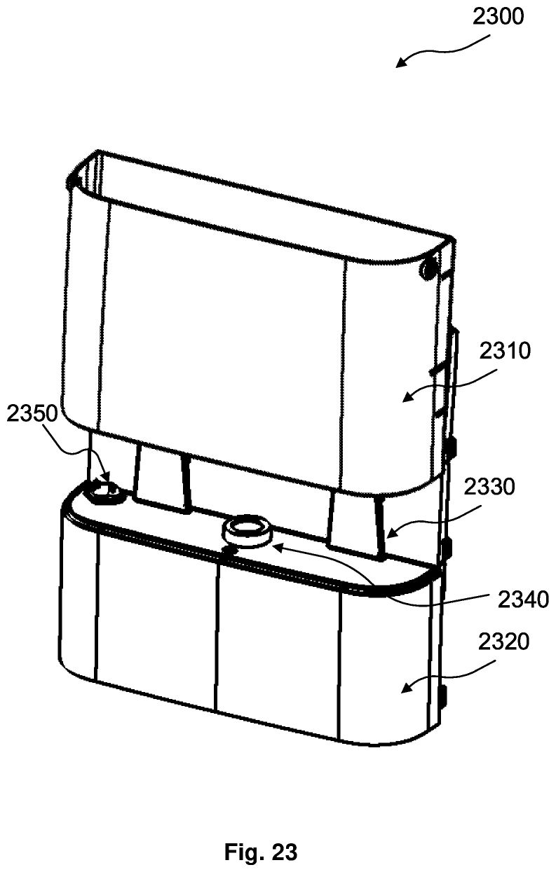

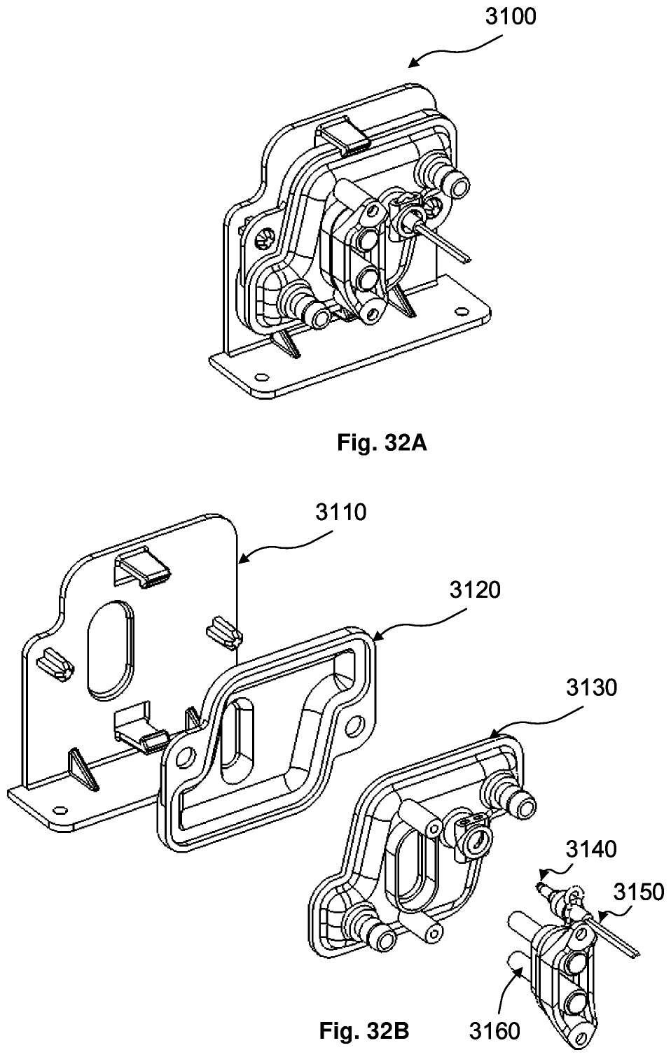

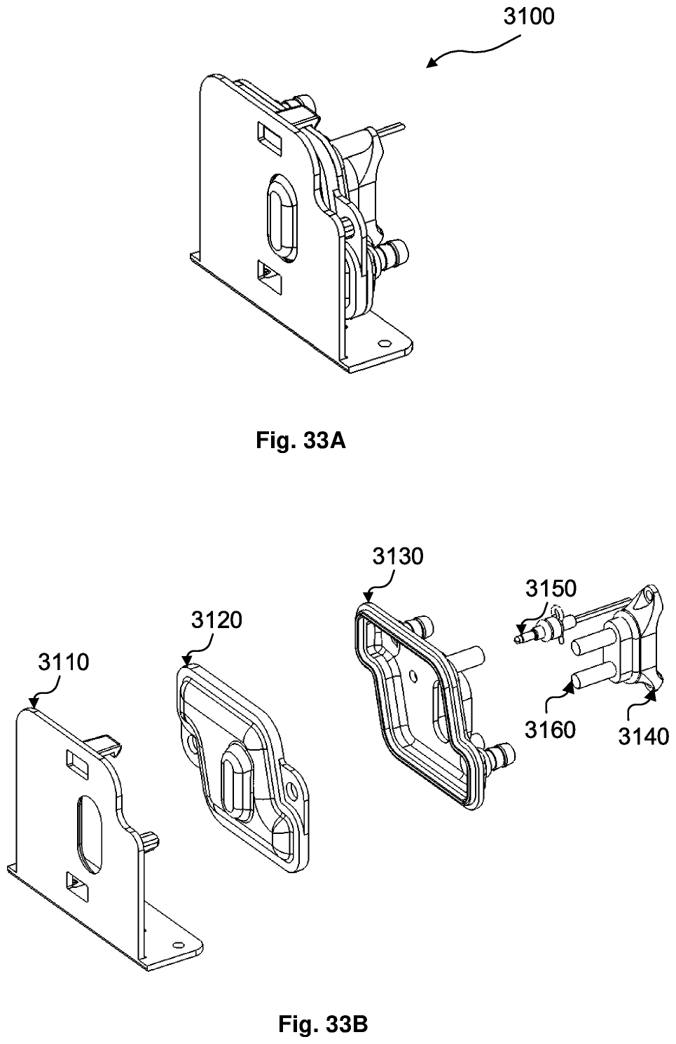

The first sensor assembly 240 preferably comprises two metal electrodes made with non-corrosive material such as stainless steel. The second sensor assembly 250 is preferably a metal tube through which the filtered liquid flows to the pump 108. The metal tube is preferably made from non-corrosive material such as stainless steel. In alternative arrangements, each of the first sensor assembly and the second sensor assembly is an induction sensor shown in FIG. 13. The temperature sensor 270 is preferably a negative-temperature-coefficient (NTC) sensor or any other kind of temperature sensor configured to measure water temperature before or after treatment. Alternative configurations of the sensor assemblies are discussed with reference to FIGS. 23-33B. Other configurations of the sensor assemblies are also possible.

The controller 260 is configured to determine the degree of purity of the liquid. Conductivity of the liquid depends on ionic contents of the liquid. The hardness of the liquid in the water tank 210 is measured via the first sensor assembly 240. The first sensor assembly 240 comprises two metal electrodes. The controller 260 applies voltage to the electrodes. Once voltage (5V) is applied between the electrodes, the electrodes will conduct (to some degree) and current will flow, or it will be an open circuit (high impedance and low conductivity signifying that water is pure). For example, the first sensor assembly may comprise an electrode A and an electrode B. The electrode A may be charged at 5V and the electrode B may be controlled to flow to ground. The impedance of the electrodes A and B depends on water hardness. The signal indicating impedance of the electrodes A and B is sent to the controller 260 for further processing. For example, an electrical signal may be detected at the first electrode A of the sensor assembly. The electrical signal may correspond to a voltage across the first and second electrodes of the sensor assembly.

In alternative implementations, when induction sensors are used to measure water permeability, the voltage detected at the induced coil may be sent to the controller 260 for further processing.

The controller controls the second sensor assembly 250 in a similar manner.

Over a period of time, energising the electrodes in the same polarity may cause metal migration and a collection of residual ions on the electrode. To reduce the effect of metal migration, the controller 260 reverses polarity of the electrodes after one or more reading cycles, i.e. in the next reading cycle the electrode B will receives 5V and Electrode A will flow to ground.

The collected impedance measurements are read by the controller 260 for further processing to monitor the performance of the filter assembly 220. The controller 260 is configured to monitor reliability and life span of the filter assembly 220 in the espresso coffee machine 100. The controller 260 determines input liquid ionic content, e.g. the degree of input liquid purity or quality, and output liquid ionic content, e.g. the degree of output liquid purity or quality. If a difference between the measured input liquid purity and the measured output liquid purity is below a comparison threshold, either the filter assembly 220 is old and no longer filtering liquid correctly and thus needs to be changed, or the liquid is pure. In some implementations, the comparison threshold is set to be 0. The controller 260 checks whether the liquid is pure by comparing the first electrical signal with the conductivity threshold (also referred to as “first threshold”). If the liquid is pure, and the controller skips other measurements.

In other implementations, rather than having the first sensor assembly 240 and the second sensor assembly 250, the appliance 100 may include a single sensor assembly configured to generate a signal to be read by the controller to monitor performance of the filter assembly 220. For example, in some implementations, only the second sensor assembly 250 which is positioned after the filter assembly 220 in the liquid flow path 200 is used to estimate the performance of the filter assembly. In such an arrangement, the second sensor assembly 250 may be used to generate a signal indicating ionic content of treated liquid, e.g. the degree of output liquid purity or quality. Similar to other arrangements, the generated signal is read by the controller 260. The controller 260 then uses the signal received from the second sensor assembly 250 to approximate the quality or performance of the filter assembly 220. If the controller 260 receives a signal from the second sensor assembly 250 indicating that water hardness is above a preprogramed threshold, the controller 260 may determine that the filter is no longer reliable and needs to be changed.

Alternatively, a signal received from the first sensor assembly 240 can be used to approximate the quality or performance of the filter assembly 220. In such an arrangement, the second sensor assembly 250 may not be required and the appliance 100 may only include the first sensor assembly 240 placed before the filter assembly 220 in the untreated liquid. In this arrangement, the first sensor assembly 240 may be configured to generate a signal indicating ionic content of untreated liquid, e.g. the quality of untreated water in response to use of the appliance 100. The controller 260 may use the generated signal to increment a counter stored in memory of the controller 260 in response to use of the appliance 100. The incremented counter represents accumulated quality of the untreated water filtered over time or about to be filtered. The controller 260 may then compare the counter with a threshold number (for example the system may keep a count of water quality over time) and signal to the user to replace at least a portion of the filter assembly 220 if the accumulated counter is above the threshold number. The threshold number may be stored in memory of the controller 260 and is typically specific for a particular filter assembly 220. The threshold number can vary depending on capacity of the filter assembly 220 to filter ions of minerals. For example, when the user fills up the water tank 210, the first sensor assembly 240 may measure the quality of water which may be different depending on different sources of water. Upon N cumulative readings and/or the counter reaching a certain water quality threshold, e.g. over 30 days, the controller 260 may trigger an alert to the user to replace the filter assembly 220.

The controller 260 is controlled by a processor 305 executing instructions of FIGS. 9 to 12 stored in internal storage (“memory”) 309 to monitor the performance of the filter assembly 220 and indicate the user interface system of the appliance 110 that the filter assembly requires replacement at least in part and/or the remaining life span of the filter assembly 220. The controller 260 is discussed in more detail below with references to FIGS. 3A and 3B.

In a preferred implementation, the two metal electrodes 240 and a temperature sensor 270 are integrated into the espresso coffee machine with the built-in or removable water tank 210. The water tank 210 has a filter 270 attached to the tank water outlet. A tube type electrodes/sensor 250 is attached to a water outlet tube 230. Based on electrical conductivity measurements taken as discussed below, the degree of water purity before and after filtering water can be determined and checked if the water in the tank is above a given conductivity or hardness threshold. If the water is above the given hardness threshold, i.e. the water is hard, then efficiency of the filter is determined based on the difference in electrical conductivity of the filtered and unfiltered water. The system periodically measures the efficiency of the filter and based on the trend of the measured efficiency can determine the expected life of the filter. If the efficiency of the filter is lower than a threshold, the system indicates to the user to replace the filter.

By following the above approach, the performance of the filter assembly 220 can be monitored and the controller 260 can indicate to the user, for example via a display screen of the user interface system of the appliance 100, when replacement of the filter assembly may be required. In doing so, the user is more aware when to replace the filter thereby reducing the risks of minerals building up on the internal components of the appliance 100 which otherwise could have been filtered by the filter assembly had it worked efficiently.

FIGS. 3A and 3B collectively form a schematic block diagram of the controller 301 including embedded components, upon which the method of controlling an appliance 100 to make a beverage shown in FIGS. 9 to 12 described below are desirably practiced.

As seen in FIG. 3A, the electronic device 301 comprises an embedded controller 302. Accordingly, the electronic device 301 may be referred to as an “embedded device.” In the present example, the controller 302 has a processing unit (or processor) 305 which is bi-directionally coupled to an internal storage module 309. The storage module 309 may be formed from non-volatile semiconductor read only memory (ROM) 360 and semiconductor random access memory (RAM) 370, as seen in FIG. 3B. The RAM 370 may be volatile, non-volatile or a combination of volatile and non-volatile memory.

The electronic device 301 includes a display controller 307, which is connected to a video display 314, such as a liquid crystal display (LCD) panel or the like. The display controller 307 is configured for displaying graphical images on the video display 314 in accordance with instructions received from the embedded controller 302, to which the display controller 307 is connected.

The electronic device 301 also includes user input devices 313 which are typically formed by keys, a keypad or like controls. In some implementations, the user input devices 313 may include a touch sensitive panel physically associated with the display 314 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

Typically, the electronic device 301 is configured to perform some special function. The embedded controller 260 or 302, possibly in conjunction with further special function components 310, is provided to perform that special function.

The methods described above may be implemented using the embedded controller 302, where the processes of FIGS. 9 to 12 may be implemented as one or more software application programs 333 executable within the embedded controller 302. The electronic device 301 of FIG. 3A implements the described methods. In particular, with reference to FIG. 3B, the steps of the described methods are effected by instructions in the software 333 that are carried out within the controller 302. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 333 of the embedded controller 302 is typically stored in the non-volatile ROM 360 of the internal storage module 309. The software 333 stored in the ROM 360 can be updated when required from a computer readable medium. The software 333 can be loaded into and executed by the processor 305. In some instances, the processor 305 may execute software instructions that are located in RAM 370. Software instructions may be loaded into the RAM 370 by the processor 305 initiating a copy of one or more code modules from ROM 360 into RAM 370. Alternatively, the software instructions of one or more code modules may be pre-installed in a non-volatile region of RAM 370 by a manufacturer. After one or more code modules have been located in RAM 370, the processor 305 may execute software instructions of the one or more code modules.

The application program 333 is typically pre-installed and stored in the ROM 360 by a manufacturer, prior to distribution of the electronic device 301. The second part of the application programs 333 and the corresponding code modules mentioned above may be executed to implement one or more graphical user interfaces (GUIs) to be rendered or otherwise represented upon the display 314 of FIG. 3A. Through manipulation of the user input device 313 (e.g., the keypad), a user of the device 301 and the application programs 333 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 3B illustrates in detail the embedded controller 260, also shown as 302, having the processor 305 for executing the application programs 333 and the internal storage 309. The internal storage 309 comprises read only memory (ROM) 360 and random access memory (RAM) 370. The processor 305 is able to execute the application programs 333 stored in one or both of the connected memories 360 and 370. When the electronic device 301 is initially powered up, a system program resident in the ROM 360 is executed. The application program 333 permanently stored in the ROM 360 is sometimes referred to as “firmware”. Execution of the firmware by the processor 305 may fulfil various functions, including processor management, memory management, device management, storage management and user interface.

The processor 305 typically includes a number of functional modules including a control unit (CU) 351, an arithmetic logic unit (ALU) 352, a digital signal processor (DSP) 353 and a local or internal memory comprising a set of registers 354 which typically contain atomic data elements 356, 357, along with internal buffer or cache memory 355. One or more internal buses 359 interconnect these functional modules. The processor 305 typically also has one or more interfaces 358 for communicating with external devices via system bus 381, using a connection 361.

The application program 333 includes a sequence of instructions 362 though 363 that may include conditional branch and loop instructions. The program 333 may also include data, which is used in execution of the program 333. This data may be stored as part of the instruction or in a separate location 364 within the ROM 360 or RAM 370.

In general, the processor 305 is given a set of instructions, which are executed therein. This set of instructions may be organised into blocks, which perform specific tasks or handle specific events that occur in the electronic device 301. Typically, the application program 333 waits for events and subsequently executes the block of code associated with that event. Events may be triggered in response to input from a user, via the user input devices 313 of FIG. 3A, as detected by the processor 305. Events may also be triggered in response to other sensors and interfaces in the electronic device 301.

The execution of a set of the instructions may require numeric variables to be read and modified. Such numeric variables are stored in the RAM 370. The disclosed method uses input variables 371 that are stored in known locations 372, 373 in the memory 370. The input variables 371 are processed to produce output variables 377 that are stored in known locations 378, 379 in the memory 370. Intermediate variables 374 may be stored in additional memory locations in locations 375, 376 of the memory 370. Alternatively, some intermediate variables may only exist in the registers 354 of the processor 305.

The execution of a sequence of instructions is achieved in the processor 305 by repeated application of a fetch-execute cycle. The control unit 351 of the processor 305 maintains a register called the program counter, which contains the address in ROM 360 or RAM 370 of the next instruction to be executed. At the start of the fetch execute cycle, the contents of the memory address indexed by the program counter is loaded into the control unit 351. The instruction thus loaded controls the subsequent operation of the processor 305, causing for example, data to be loaded from ROM memory 360 into processor registers 354, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 333, and is performed by repeated execution of a fetch-execute cycle in the processor 305 or similar programmatic operation of other independent processor blocks in the electronic device 301.

The controller 260 under control of the processor 305 is configured to determine electrical conductivity of the untreated liquid based on the first electrical signal and determine electrical conductivity of the treated liquid based on the second signal. As discussed above, each of the sensors 240 and 250 may include a first electrode and a second electrode being spaced apart from each other. The controller 260 may power by the electrodes such that, within one sensor assembly, a first one of the electrodes receives voltage from the controller and a second one of the electrodes is grounded. The polarity of the electrodes may be then reversed such that the second electrode receives voltage from the controller and the first electrode is grounded after one or more cycles of determining the electrical conductivity to prevent or reduce metal migration. In other examples, the controller is configured to cause the first electrode to have a higher electrical potential than the second electrode for a first set of one or more cycles and cause the second electrode to have a higher electrical potential than the first electrode for a second set of one or more cycles.

FIG. 4 shows a schematic diagram 400 of one implementation of the first sensor assembly 240. The second sensor assembly 250 may have similar configuration of the first sensor assembly 240. The first sensor assembly 240 and the second sensor assembly 250 are powered from different ports of the controller 260.

According to one implementation of the present disclosure, the controller 260 (a portion of which is schematically shown as microcontroller 435) powers an electrode 410 of an electrical conductivity probe (“a first electrode”) from a digital pin 442 through a completion resistor R1 430. The completion resistor R1 430 may have resistance between 200 Ohm to 1000 Ohm. The controller 260 powers an electrode 420 of the probe (“a second electrode”) from a digital pin 462. The microcontroller 435 is powered from a pin 437 with a return path to the ground 438. The common collector voltage Vcc at the pin 437 is typically 5V. The completion resistor properties may be known in advance and stored in memory of the controller 260. The completion resistor R1 430 can be changed depending on the electrode construction of the sensors. In one implementation the completion resistor R1 of about 500 Ohm may be used.

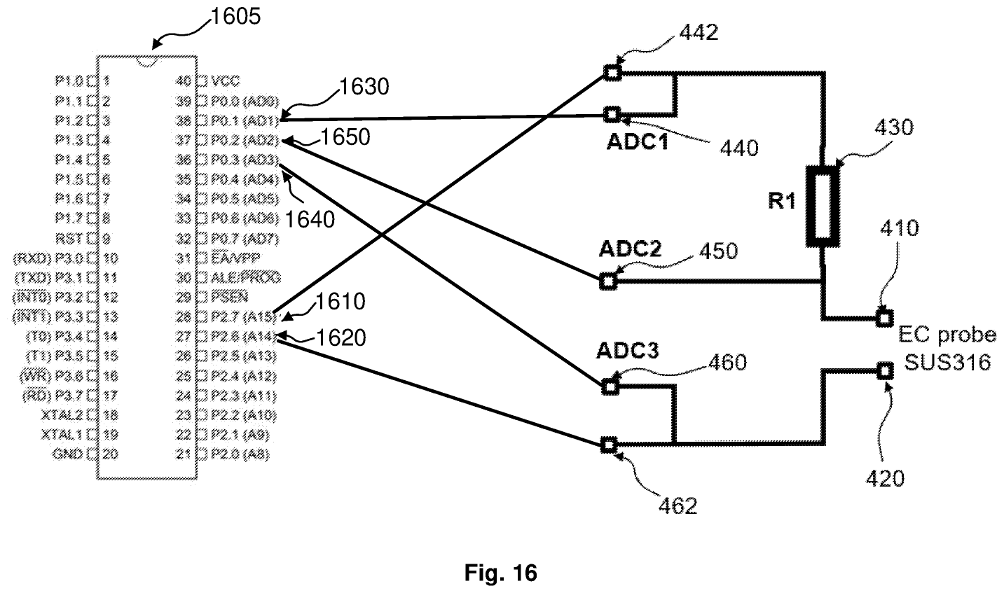

The microcontroller 435 may include analog-to-digital (ADC) pins ADC1 440, ADC2 450 and ADC3 460. As shown in FIG. 16, the digital pins 442 and 462 may correspond to pins 1610 and 1620 respectively on the integrated circuit 1605 of the microcontroller 435. The ADC pins 440, 450 and 460 may correspond to pins 1630, 1650 and 1640 respectively on the integrated circuit 1605 of the controller 435.

The value SenseGND read at the pin 460 corresponds to voltage of the electrode 420 flowing to the ground 438. The value Sense Vin read at the pin 440 corresponds to voltage applied by the microcontroller 435 to the electrode 410. The value Raw read at the pin 450 corresponds to voltage detected on the electrode 410 powered by the controller taken before the completion resistor 430. The voltage Raw read at the pin 450 indicates conductivity of the liquid in which the electrodes are immersed.

The pins ADC1 440, ADC2 450 and ADC3 460 are microcontroller analog-to-digital pins configured to sample or read voltage levels SenseVin, Raw and SenseGND respectively and give a numeric output to the firmware of the controller 260. The sampling rate of the voltage values SenseVin, SenseGND and Raw may be 200 kHz. Internal resistance (schematically shown as internal resistors 445 and 465) of the microcontroller 435 causes the voltage to fluctuate. A relevant digital pin 442 or 462 of the controller 435 is effectively shorted with the corresponding ADC pin 440 or 460 respectively. The pins ADC1 440, ADC2 450 and ADC3 460 are ADC pins powered by the internal digital logic within the microcontroller 435. The pins 440, 450 and 460 are configured to read the voltages at the points shown in FIG. 4 and transform the read voltage into a number to be used in the firmware of the controller 435 to determine the degree of water purity.

The firmware of the microcontroller 435 is programmed to control or set the digital pin output so that the relevant digital pin powers sensor circuit, for example at 5V. Due to internal resistance of the microcontroller 435 that voltage may be not exactly 5V, it might me 4.9 at time “t”. It is therefore advantageous to have digital pins 442 and 462 connected to the 3 ADC pins 440, 450 and 460 for reading or sampling the voltage for computation. The firmware may be also programmed to switch polarity of the digital pins 442 and 462 thereby controlling polarity of the corresponding ADC pins to prevent metal migration.

When the microcontroller 435 is programmed, the programming environment includes a console that reads and outputs the ADC pin values such as SenseVin, Raw and SenseGND, to the firmware of the controller 260 to determine the degree of purity of the liquid. The pins ADC1 440, ADC2 450 and ADC3 460 provide a numeric output, which is then read by the firmware of the controller 260 to monitor performance of the filter assembly 240.

The controller 260 can determine impedance of the liquid using the following equation:

$${R}_{e c} = R 1 * ( Raw - SenseGND ) / ( Sense V in - Raw ) \qquad ( 1 )$$

The R_{ec} value corresponds to an electrical signal indicative of conductivity of the liquid. If the assembly 400 is the first sensor assembly 240, the value R_{ec} determined by the controller 260 for the first sensor assembly indicates ionic content or electrical conductivity of the untreated liquid. If the assembly 400 is the second sensor assembly 250, the value R_{ec} determined by the controller 260 for the second sensor assembly indicates electrical conductivity of the treated liquid.

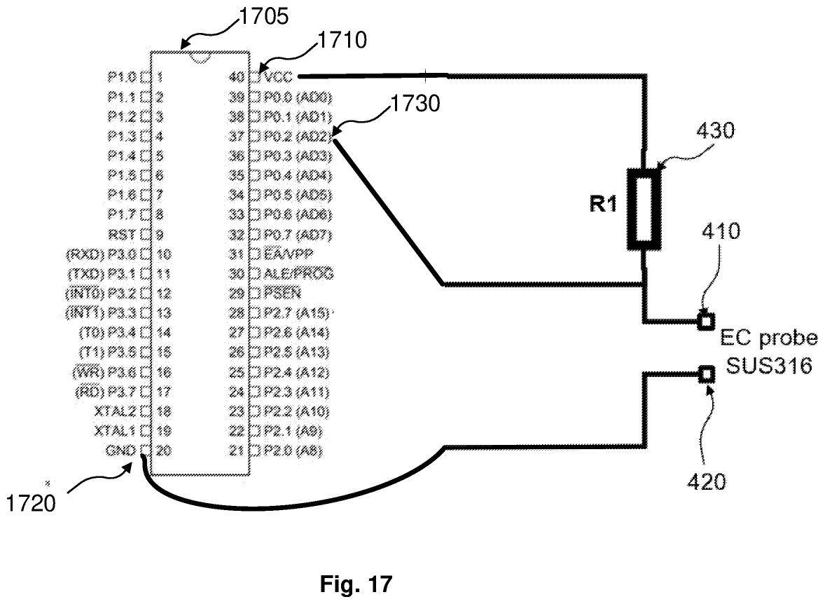

In an alternative implementation as shown in FIG. 17, the controller 260 may operate on the Vcc/Gnd line, in which case readings SenseVin at pin 1710 of the integrated circuit 1705 of the controller 260 and SenseGND at pin 1720 of the integrated circuit 1705 are constant. Given that values Sense Vin and SenseGND may be constant in this implementation, the controller 260 may be able to determine relative conductivity of the liquid or approximate the conductivity, as the case may be, using only the electrical signal Raw. In this implementation, the electrical signal Raw from the electrode 410 is read at the pin 1730 of the integrated circuit 1705 of the controller 260. The electrode 410 is powered by the pin 1710 of the circuit 1705. The pin 1730 is coupled with the electrode 410 before the completion resistor 430. As such, the voltage read at the electrode 410 may indicate conductivity of the liquid.

In alternative implementations shown in FIG. 13, each of the first sensor assembly and the second sensor assembly may be an induction sensor 1310. The induction sensor 1310 comprises two inductor coils placed proximate to each other which can measure permeability of the liquid, which is also considered as measure of ionic content of the liquid. In this implementation, the first induction sensor is configured to measure permeability of the untreated liquid and the second induction sensor is configured to measure permeability of the treated liquid.

Measurements of the permeability of the liquid are based on principles of electromagnetic induction. For example, as shown in FIG. 13, each sensor assembly 1310 may have two spaced apart coils 1320 and 1330. The first coil 1320 may be attached to the top of a tube 1340 and the second coil 1330 may be attached to the bottom of the tube 1340. The first coil 1320 may be inducing an electrical signal, e.g. a current and/or voltage, in the second coil 1330 when first coil is powered by the controller 260 and the liquid is flowing through the tube 1340. The liquid may flow through the tube 1340. The coils 1320 and 1330 may be attached to an internal surface or an external surface of the tube 1340. Alternatively, the coils 1320 and 1330 may be attached to the internal surface of the tank 210. In some implementations, the flow is temporarily stopped when measurements are taken to increase the accuracy.

The controller 260 is configured to determine ionic content or the degree of purity of the liquid based on the voltage induced in the second coil. The first coil and the second coil may be coupled to pins of the controller 260. Similar to the sensor assembly discussed above, the first coil 1320 may be powered by generating an AC wave due to electromagnetic induction principle from one pin of the controller 260 and measurements of the voltage induced in the second coil 1330 may be read at another pin of the controller 260. The voltage induced in the second coil 1330 (via the first coil 1320) read at one of the pins of the controller 260 is proportional to the ionic content or degree of purity of water. If the water is not pure, then the voltage induced in the other coil will be smaller (albeit the relationship between the voltage induced in the other coil and the ionic content may not be a true linear relationship).

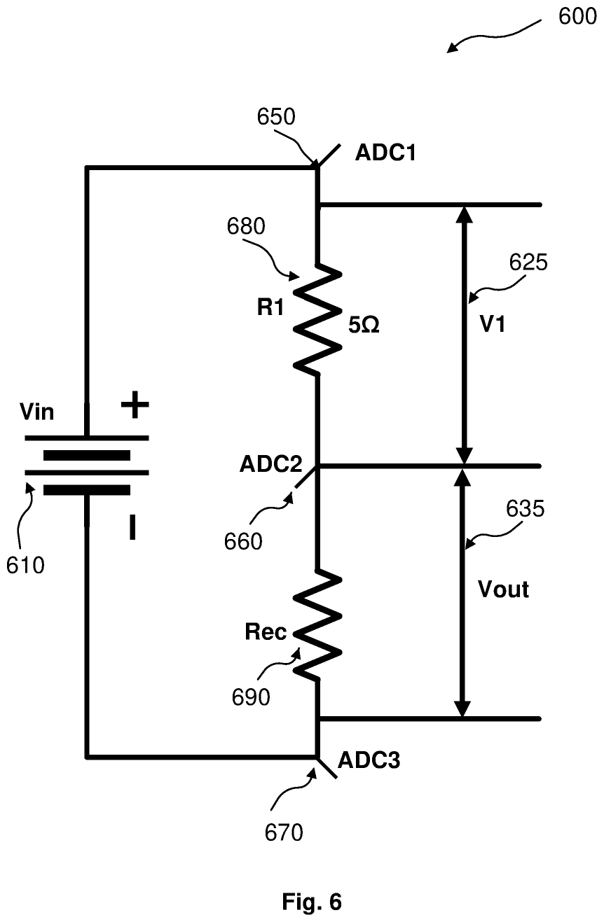

FIG. 6 shows schematic diagram of an electronic circuit of the sensor assembly of FIG. 4 and outlines an overall mechanism for measuring the impedance of the liquid. FIG. 6 shows input voltage 610 from the controller 260, analog-to-digital pins 650, 660, 670, resistors 680 and 690, voltage V1 625 and output voltage 635.

The controller 260 powers the first electrode as shown by 610. The controller 260 receives measurements from ADC1 (Sense Vin) 650, ADC 2 (Raw) 660 and ADC3 (SenseGND) 670. SenseVin 650 indicates voltage, for example of 5V, applied to the first electrode, SenseGND 670 indicates voltage flowing to the ground, and ADC2 660 (Raw) indicates voltage detected on the powered electrode (first electrode in this case).

The following assumptions are made:

$$\begin{matrix}R 1 / Rec = V 1 / V out \\ Rec = R 1 \times V out / V 1 \\ Sense V in = V 1 + V out + SenseGnd ( voltage law ) \\ V out = Raw - SenseGND\end{matrix} \qquad ( 2 )$$

The above assumptions are found to provide sufficient accuracy for the purposes of the present disclosure.

By solving (2) for V1, V1 can be written as follows:

$$V 1 = Sense V in - V out - SenseGND + Sense V in - Raw \qquad ( 3 )$$

Then using equations (2) and (3), impedance Rec can be written as follows:

$$Rec = ( Raw - SenseGND ) \times R 1 / ( Sense V in - Raw ) \qquad ( 4 )$$

In other words, impedance Rec is proportionate to the resistance R1 of the completion resistor of the first electrode and a difference between the sensed voltage at the first electrode and the voltage flowing to the ground SenseGND. The impedance Rec is also inverse proportionate to a difference between the voltage applied to the first electrode by the controller 260 and the sensed voltage at the first electrode.

FIG. 5 shows a schematic diagram 500 of the temperature sensor assembly 270. The temperature sensor assembly 270 comprises an NTC thermistor 510 and a resistor 520 connected serially. The temperature sensor assembly 270 is coupled to the controller 260 via an analog-to-digital pin 530. The controller 260 reads voltage measured by the thermistor 510 via the pin 530. The resistor 520 is grounded 550 and the thermistor 510 is supplied with Vdd 540.

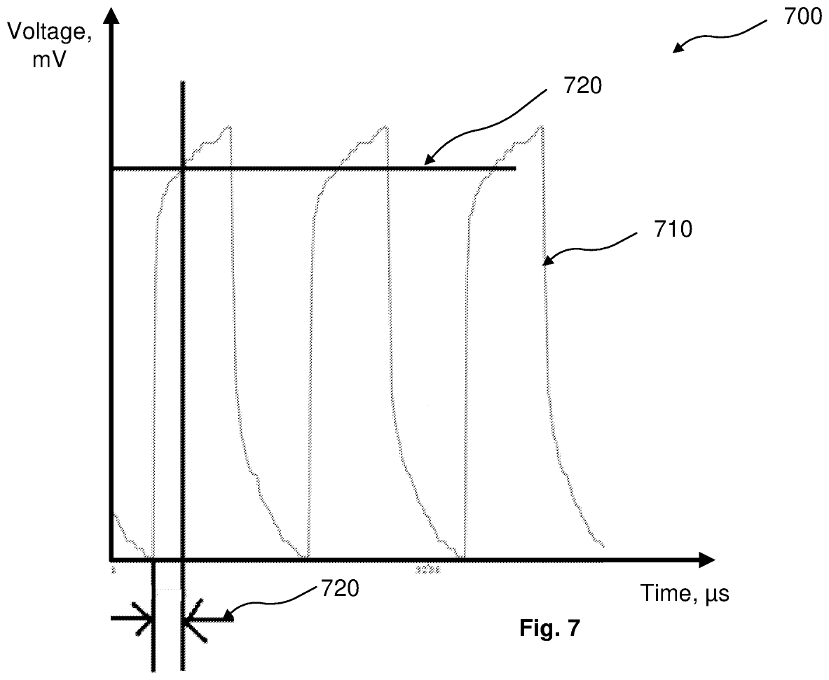

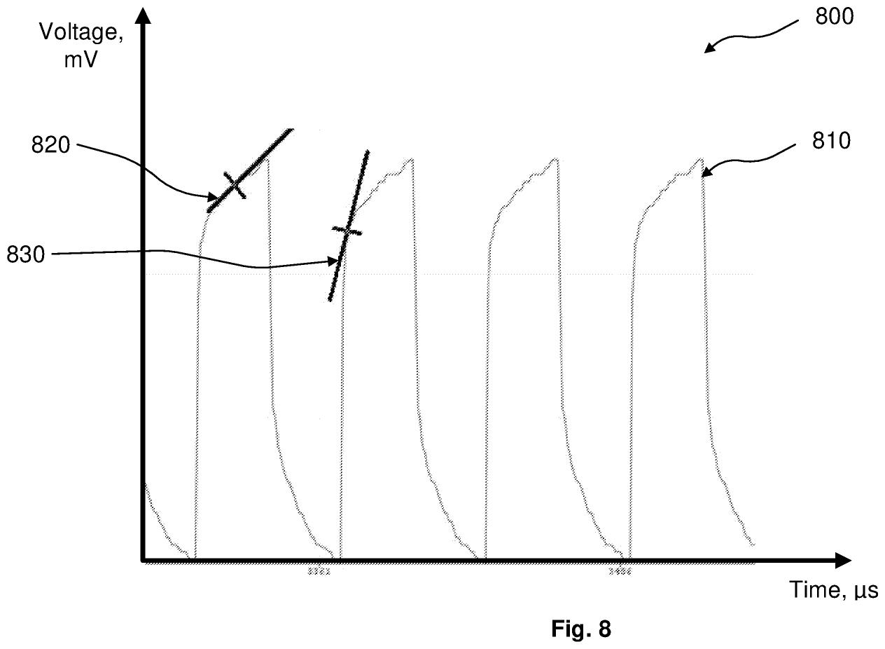

FIG. 7 and FIG. 8 depicts different implementations of taking voltage measurements for determining the impedance of the liquid.

When a voltage is applied to the electrodes 410 and/or 420, the electrodes are not charged instantaneously, rather the charge is building up like in a capacitor. As such, voltage measurements taken at different points in time may vary slightly as shown as a voltage curve 710 and a voltage curve 810 in FIGS. 7 and 8 respectively, i.e. measurements taken at different points in time will yield slightly different voltages and consequently slight off measurements of electrical conductivity of the liquid.

In one implementation 700 shown in FIG. 7, voltage measurements can be taken at a pre-determined point in time 720 from the beginning of powering the first and/or second electrode, for example at 100 μs. In accordance with experiments conducted, the time period of 100 μs from the beginning of applying voltage of the electrode appears to yield the same voltage measurement across a plurality of pulses of the voltage signal, i.e. across the signal train. The voltage read at the pin 450 of the controller 260 at that pre-determined point in time is then used for further processing, for example, to determine conductivity of the liquid. Additionally, the voltage at pins 440 and 460 can be simultaneously read.

In an alternative implementation 800 shown in FIG. 8, a voltage measurement is used for determining conductivity of the liquid if an angle of the gradient of the voltage chart 810 determined at the point corresponding to that voltage measurement is about 45 degrees. In this implementation, the controller 260 determines the gradient of the voltage chart 810, selects a point in the voltage chart 820 at which angle of the gradient is about 45 degrees and uses measured voltage value for further calculations of the conductivity of the liquid. The selected angle of 45 degrees is chosen experimentally so that the voltage measurement is expected to be relatively close in time to the beginning of the pulse, i.e. calculations can be done faster, while being relatively stable compared to gradients appearing closer to the beginning of the pulse, such as 830. Fluctuation in gradients typically provide more fluctuated readings. Other angles for the gradient can also be used depending on accuracy requirements and properties of the electrodes. For example, a different angle for the gradient may be used for electrodes made from metal other than stainless steel.

In other implementations, the controller 260 may wait for voltage saturation, for example, additional 2-4 seconds.

FIG. 9 is a flow diagram illustrating steps performed by the controller 260 under control of the processor 305 executing instructions stored in memory 309.

The controller 260 under control of the processor 305 executes a method 900 of controlling the appliance 100 for making a beverage. As discussed above, the appliance 100 comprises at least one beverage making component, such as the pump 108 and/or heater 110, and the liquid flow path or a hydraulic line 107 providing the liquid to the at least one beverage making component. The appliance 100 may also comprise a filter assembly 106 integrally formed within the appliance 100 and filtering the liquid in the liquid flow path 107.

The method 900 begins with determining (or reading) at step 910 a first electrical signal indicative of a first ionic content value, e.g. electrical conductivity, of the untreated liquid in the tank 102. As discussed above, the controller 260 may read the voltage value from the pin 450 as the first electrical signal. Additionally, the controller 260 may read voltage values at pins 440 and 460 simultaneously every time when reading voltage values at the pin 450 to increase accuracy and repeatability of the results. However, if the controller 260 operates on the Vcc/Gnd line and the pins are not powered by digital pins, voltage values at pins 440 and 460 are constant and do not require to be read.

The controller 260 then moves to step 920 of determining a second electrical signal indicative of a second ionic content value, e.g. electrical conductivity, of the treaded liquid in the conduit 230. Similar to step 910, the second electrical signal may be read at the pin 450 of the second sensor assembly corresponding to measured voltage at the powered electrode. Steps 910 and 920 are performed periodically, for example, hourly or every time a user makes a beverage.

Once the first electrical signal and the second electrical signals are obtained, the method 900 proceeds to step 930 to monitor performance of the filter assembly 106 based on the first electrical signal and the second electrical signal. Step 930 is described in more detail with references to FIG. 10.

If the controller 260 operates on the Vcc/Gnd line, the performance of the filter assembly 106 may be monitored directly using the first electrical signal and the second electrical signal subject to below described normalization.

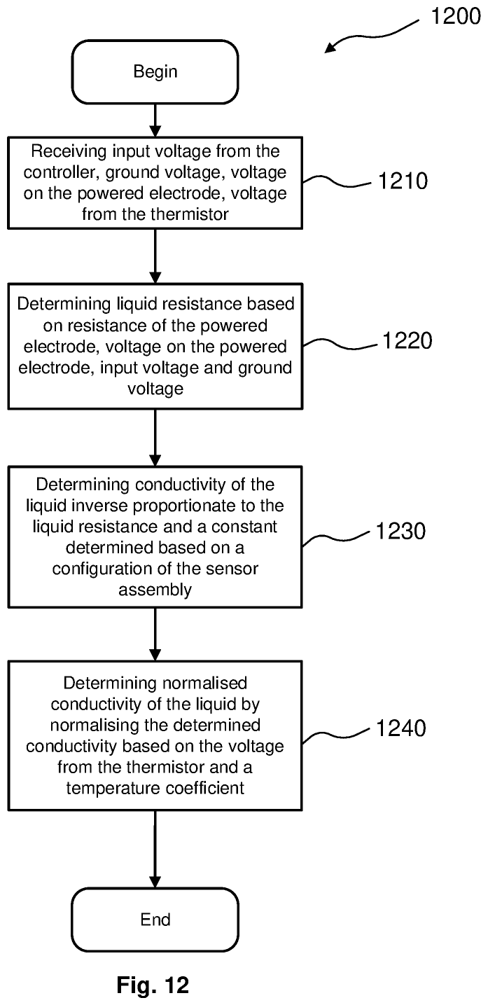

In other implementations, the controller 260 determines the first ionic content value, e.g. electrical conductivity, of the untreated liquid based on the first electrical signal and determines the second ionic content value, e.g. electrical conductivity, of the treated liquid based on the second electrical signal to monitor the performance of the filter assembly. The process of determining the ionic content values, e.g. electrical conductivity, of liquid is discussed in more detail with references to FIG. 12.

While monitoring the performance of the filter assembly 106, the controller 260 may send instructions to a display screen of the user interface system to display a signal or warning indicating that at least a portion of the filter assembly 106 needs to be replaced. The signal may be sent is response to comparing the first ionic content value and the second ionic content value, e.g. the conductivity value of the treated liquid with the conductivity value of the untreated liquid. Alternatively, the signal may be sent in response to comparing the inverse of the first electrical signal and the inverse of the second electrical signal.

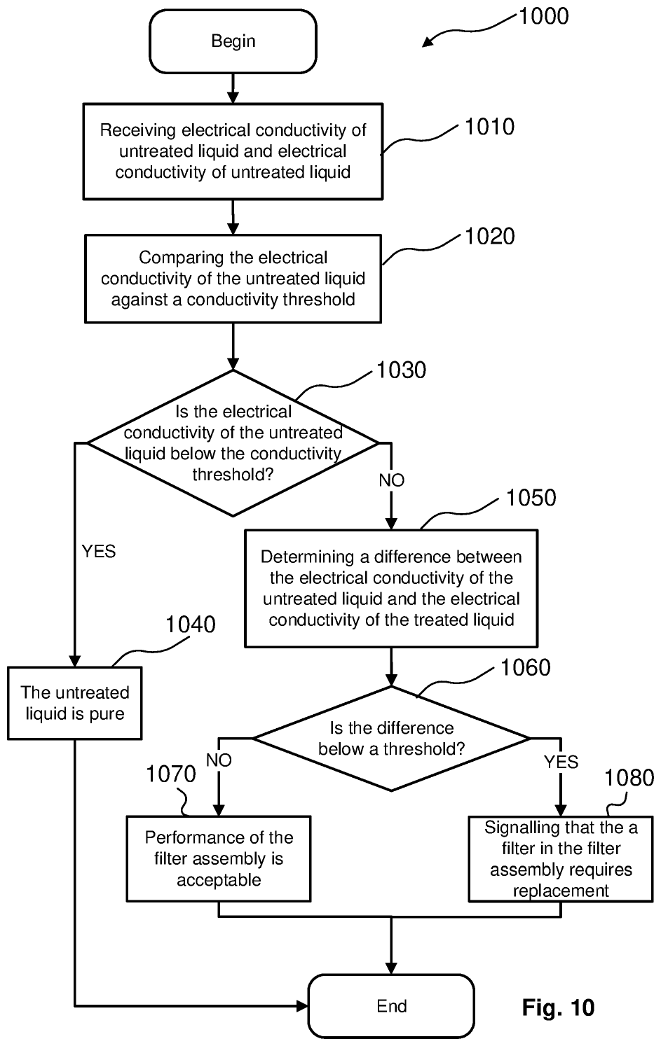

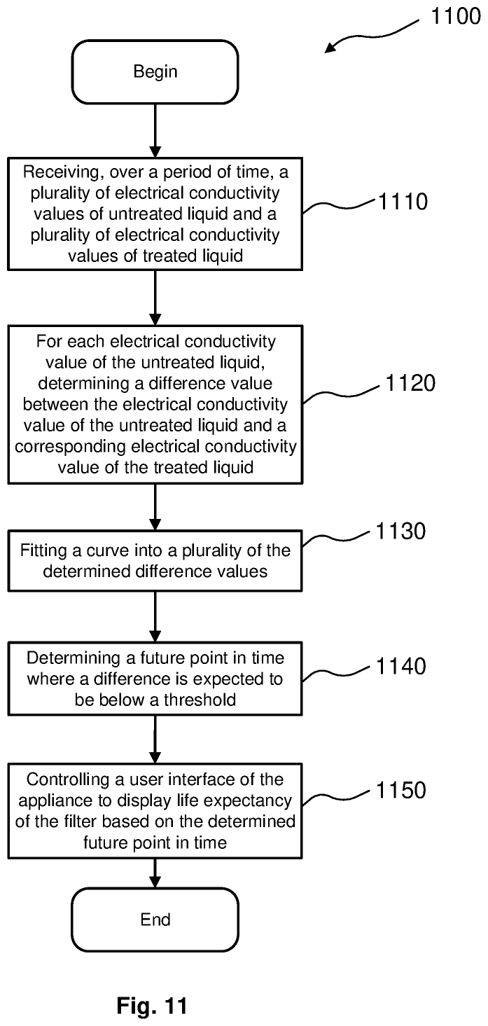

Additionally, or alternatively, as part of the monitoring in step 930, the controller 260 may determine life expectancy of the filter assembly 106. The life expectancy can be predicted by determining a trend based on a plurality of electrical conductivity values recorded for the untreated liquid and a plurality of corresponding electrical conductivity values recorded for the treated liquid. The process of determining the life expectancy of the filter assembly 106 is described in more detail with references to FIG. 11. The determined life expectance may be then communicated to the display screen of the user interface system.

The method 900 then concludes.

FIG. 10 shows a method 1000 of monitoring the performance of the filter assembly 106 based on the electrical conductivity of the untreated liquid and the electrical conductivity of untreated liquid under control of the processor 305.

The method 1000 begins at step 1010 of receiving the electrical conductivity of the untreated liquid and the electrical conductivity of untreated liquid. In one implementation, the electrical conductivity can be determined either using equations (5) and (6) respectively. In a preferred implementation, the ionic content value, e.g. electrical conductivity, is determined as described below with references to FIG. 12.

The method 1000 then moves to step 1020 where the processor 305 compares the electrical conductivity of the untreated liquid against a conductivity threshold programmed into the firmware of the controller 260 or stored in memory 309. If the electrical conductivity of the untreated liquid is below the conductivity threshold at step 1030, the liquid is considered to be pure at step 1040 and no further processing is performed. The method 1000 then concludes.

If the electrical conductivity of the untreated liquid is above or equal to the conductivity threshold at step 1030, the method 1000 proceeds to step 1050 where the processor 305 determines a difference between the electrical conductivity of the untreated liquid and the electrical conductivity of the treated liquid. If the determined difference is below the threshold at step 1060, the controller 260 then signals the user interface system of the appliance 100 at step 1080 that the filter assembly 107 needs to be replaced. Otherwise, the performance of the filter assembly is considered to be acceptance at step 1070. The method 1000 then concludes.

The method described above with references to FIG. 10 effectively checks whether the water in the tank 102 is pure and needs no further filtration. If the electrical conductivity of the water in the tank 102 is lower than threshold, then the water in the tank is more resistive, thus purer. No further calculations are done as input water electrical conductivity will equal output water electrical conductivity. If water in the tank is not pure, i.e. the electrical conductivity above the conductivity threshold, and if normalized (EC (tank)-EC (filter)) is less than EC (predefined-value) set at production by the manufacturer, then the controller 260 advises user to change the filter. The controller 260 can also store electrical conductivity readings into memory for regression analysis as described below with references to FIG. 11. For example, normalised EC (tank) and EC (filter) values can be periodically taken and stored in memory (i.e. every time user make a coffee). Regression analysis is used to predict filter lifecycle.

FIG. 11 shows a method 1100 executed by the processor 305 to determine life expectancy of the filter assembly 107.

The method 1100 performed by the controller 260 under execution of the processor 305 begins at step 1110 when the processor 305 receives a plurality of electrical conductivity values of untreated liquid and a plurality of electrical conductivity values of treated liquid obtained periodically over a period of time. The period of time can be, for example, several hours or days depending on the usage pattern of the appliance 100.

The method 1100 under execution of the processor 305 then proceeds to step 1120 of determining, for each electrical conductivity value of the untreated liquid, a difference value between the electrical conductivity value of the untreated liquid and a corresponding electrical conductivity value of the treated liquid. Step 1120 effectively determines corresponding pairs of conductivity values based on time when the measurements were obtained. For example, for the electrical conductivity value determined for the untreated liquid at time t₀, the processor 305 can select a conductivity value of the treated liquid which is closest in time t₀ to and taken within a predetermined interval Δt from t₀. Once corresponding pairs of conductivity values are determined, step 1120 determines a difference in the conductivity values for each pair. Pairs where the conductivity of the untreated liquid is below the conductivity threshold can be disregarded for the purposes of fitting the curve.

The method 1100 then proceeds to step 1130 where a curve is fitted into the plurality of determined difference values. The fitted curve represents a trend line for the plurality of determined difference values. The curve, i.e. the trend line, may be a straight line. At step 1140, the controller 260 uses the fitted curve to determine a future point in time where a difference is expected to be below a threshold, i.e. the filter assembly is not filtering the liquid properly. The determined future point in time serves as an indication of the life expectance of the filter assembly 107.

At step 1150, the processor 305 of the controller 260 controls the user interface to display life expectancy of the filter based on the determined future point in time. Additionally, the controller 260 may send a notification to the user interface system if the determined life expectance is less a couple of days.

The method effectively performs regression analysis by taking a dataset, apply curve fitting regression analysis and thereby predicting likely outcomes in the future. The method 1100 then concludes.

FIG. 12 shows a method 1200 of determining ionic content value, e.g. electrical conductivity, of liquid. The method is performed by the controller 260 under control of the processor 305. The method 1200 begins at step 1210 of receiving input voltage ADC1 from the controller 240, ground voltage ADC3, voltage on the powered electrode ADC2, voltage from the thermistor ADC4.

The method 1200 then moves to step 1220 where the controller 260 determining liquid resistance Rec based on resistance of the powered electrode, voltage on the powered electrode, input voltage and ground voltage using Equation 1 or Equation 4. At step 1230 the controller 260 determines conductivity of the liquid inverse proportionate to the liquid resistance Rec determined at step 1220 and a constant K determined based on a configuration of the sensor assembly using the following equation:

$$E C = 1 / ( Rec \times K ) \qquad ( 5 )$$

The constant K is determined during the design phase of the electrodes and programmed into the controller 260 of the appliance 100 during manufacturing of the appliance 100. The constant K is typically dependent on a configuration of the sensor assembly, such as shape of the electrodes, dimensions of the electrodes and distance apart between the electrodes.

Alternatively, since the constant K can be determined at manufacturing, rather than calculating electrical conductivity using equation (5), electrical conductivity can be calculated as 1/Rec and the conductivity threshold T₀ and the threshold T₁ used to evaluate the performance of the filter assembly may be adjusted based on the constant K and stored in the memory 309 of the controller 260.

The controller 260 then proceeds to step 1240 to determine normalised electrical conductivity of the liquid by normalising the determined electrical conductivity EC based on the voltage from the thermistor and a temperature coefficient as shown below:

$$EC 25 = EC / ( 1 + TempCoeff * ( t - 25 ) ) \qquad ( 6 )$$

where EC25 is normalized electrical conductivity value at 25 degrees C., t is temperature determined by the thermistor, TempCoeff is a temperature coefficient.

The temperature coefficient TempCoeff is typically in the range of 0.019 to 0.021 for water. TempCoeff of 0.02 was identified as working well for the discussed arrangements. The temperature coefficient is constant calculated during the design phase of the appliance 100 and/or sensor assembly and programmed into the controller 260 during manufacturing.

Normalisation of the electrical conductivity at step 1240 is particularly advantageous because readings at pins of the controller 260 may vary due to temperature variation rather than variation of electrical conductivity of the liquid. For example, changes in temperature may be caused by measurements obtained across different seasons, before and after heating or other variation in temperature of tap water.

The calculations of method 1200 may be delayed by up to 10 seconds after the filter assembly 107 was replaced and/or the tank 102 was filled up to stabilize the electrodes after discharge. In practice, the delay of about 2-3 seconds may be sufficient. In some implementation, to further reduce the likelihood of inaccurate readings, appliance 100 may be controlled to run the pump 108 for about 2-3 seconds prior taking readings. Inaccurate readings can be caused, for example, by residual water sitting in the tank 102 and/or conduit 107, built-up and residue ions on the sensor assemblies 109 and 111 and/or temperature differences between water in the tank 102 and in the conduit 107.

If it is not the first time for taking readings since last time the tank was filled up and the filter assembly replaced, the measurements can be taken immediately without delay. The controller 260 may continue to take readings periodically while the appliance 100 is powered on, for example, hourly.

The method 1200 concludes.

FIG. 14 shows a schematic view of a dual compartment tank 1400 in accordance with one embodiment of the present disclosure. The tank 1400 may have an inlet 1410 and an outlet 1460. The tank 1400 includes a first chamber 1420 with unfiltered or untreated liquid, such as water, a second chamber 1430 with filtered or treated liquid, such as water, and a wall 1440 separating the first chamber 1420 from the second chamber 1430. A filter assembly 1450 may be arranged within a lower portion of the wall 1440 such that substantially no untreated water flows to the second chamber 1430. The untreated water from the first chamber 1420 is filtered by the filter assembly 1450 and flows to the second chamber 1430 as shown by arrows 1442 and 1445.

In some implementations, the filter assembly 1450 may include an electrical component (not shown) in electrical communication with the controller 260 shown as 1455. The electrical component of the filter assembly 1450 may be configured to communicate to the controller 1455 an electrical signal indicating presence of the filter assembly 1450. The electrical component may be in a form of a switch. The controller 1455 may be configured to read the signal and determine whether the filter assembly 1450 is present or not and consequently bypass the process of determining performance of the filter assembly 1450 if the filter assembly 1450 is not present. It will be appreciated that the electrical component can be provided in many other forms.

The dual compartment tank 1400 may also include a first sensor assembly 1470 arranged in the first compartment 1420 and a second sensor assembly 1475 arranged in the second compartment 1430. The sensor assemblies 1470 and 1475 are placed in the lower portion of the tank 1440 and/or on the filter assembly 240 (shown here as 1450). In a preferred implementation, electrical contacts of each of the sensor assemblies 1470 and 1475 are attached to the floor (bottom) of the tank 1440 to allow the tank 1440 to be removably attached to the appliance 100. As such, when the tank 1400 is attached to the appliance 100, at least one of the sensor assemblies 1470 and 1475 becomes electrically coupled with the controller 1455 via corresponding electrical contact, for example, in the form of pins. For example, as shown in FIG. 15A, the tank 1400 may have electrical contacts 1510 and 1515 attached to the floor of the tank and configured to be electrically coupled with corresponding pins of the controller 1455.

The dual compartment tank 1400 may also include a temperature sensor assembly 1480 attached to any wall of the tank 1440 anywhere in the water path and preferably in the lower portion of the tank 1440. Each of the sensor assemblies 1470, 1475 and 1480 is coupled to the controller 1455.

In operation of the appliance 100, water may flow from the water source 1410 into the first chamber 1420. Quality or a degree of purity of the unfiltered water in the first chamber may then be determined by the controller 1455 based on a signal generated by the first sensor assembly 1470. As discussed above, only one sensor assembly is sufficient for estimating the performance of the filter assembly and, accordingly, the first sensor assembly 1470 may not be needed in some implementations.

The unfiltered water from the first chamber 1420 may then flow to the filter assembly 1450 to be filtered and output to the second chamber 1430. The filtered water from the second chamber 1430 is then supplied to beverage making components of the appliance 100.

The filter 1450 may be monitored by the controller 1455 based on a signal generated by the second sensor assembly 1475, the signal generated by the first sensor assembly 1470 or both of them. As discussed above, the performance of the filter 1450 may be estimated using data from any or both of the first sensor assembly 1470 and the second sensor assembly 1475. A signal received from the temperature sensor 1480 may be used to improve accuracy when estimating the filter performance. However, in some implementations, for example, when only the first filter assembly is used, the temperature sensor 1480 may not be required.

FIGS. 15A and 15B show perspective views 1500 and 1550 of a removable tank 1505 in accordance with one implementation of the present disclosure. The removable tank 1505 may have slots 1510 and 1515 at the bottom configured to receive electrodes 1560 and 1565 respectively. The electrodes 1560 and 1565 are integrated within a portion 1555 of the appliance 100. The electrodes 1560 and 1565 are configured to be in electrical communication with the slots 1510 and 1515 respectively to form detachable electrode connectors for measuring a degree of water purity.

As discussed above, the present disclosure relates to controlling the appliance 100. In particular, the present disclosure relates to determining a first ionic content value of the liquid, determining if the liquid is pure, impure or a descaling agent based on the determined first ionic content value, and controlling the appliance 100 based on the determining.

In some implementations, in addition to filtering the liquid, controlling may involve controlling of periodic descaling to remove ions of minerals built up on internal components of the appliance over time. To control descaling of the appliance 100 in accordance with some implementations of the present disclosure, at least one sensor assembly can be used to generate a signal indicative of ionic content of the liquid in at least one receptacle of the appliance 100. The at least one sensor assembly can be the first sensor assembly 109 and/or second sensor assembly 111. The at least one receptacle can be the tank 102, the conduit 107 or any other conduit of the appliance 100 through which the liquid is flowing.

As discussed above, the at least one sensor assembly generates an ionic content signal comprising one or more ionic content values. Each ionic content value is indicative of ionic content of the liquid. The ionic content value can correspond either to electrical conductivity of the liquid or magnetic permeability of the liquid.

As above, the controller 260 of the appliance 100 is coupled with the at least one of the sensor assemblies 109 or 111 for the purposes of controlling descaling. The controller 260 is configured to determine the first ionic content value indicative of ionic content of the liquid in the at least one receptacle of the appliance based on the ionic content signal received from the at least one of the sensor assemblies 109 or 111.

The controller 260 may be also configured to determine whether the appliance 100 is in a descaling mode. For example, the controller 260 may be detecting if a descaling mode has been activated. The descaling mode can be activated either automatically or selected by a user using the user interface of the appliance 100. For example, the user may select a descaling profile from a plurality of descaling profiles. Alternatively, the controller 260 may determine that the appliance 100 is in the descaling mode if the liquid is determined to be a descaling agent based on the first ionic content value.

The controller 260 is configured to determine a type of the liquid using the first ionic content value based on the determining that the appliance is in the descaling mode. The type or class of the liquid is determined in response to determining that the appliance 100 is in the descaling mode. The type or class of the liquid in the descaling mode may be synonymous to the type or class of the descaling agent. For example, if the controller 260 determines that the appliance is in the descaling mode, the controller may determine a type of the liquid as a low concentration descaling agent, a normal concentration descaling agent or a high concentration descaling agent.

A threshold range for a normal concentration descaling agent may be stored in memory 309. If the ionic content value is below the threshold range, the descaling agent can be classified as a low concentration descaling agent. If the ionic content value is above the threshold range, the descaling agent can be classified as a high concentration descaling agent. For example, in one implementation, the threshold range can be pre-programmed to be between the second threshold (1000 μS/cm) and the third threshold (2000 μS/cm). In alternative implementations, the threshold range can be selected by the user.

Alternatively, if the controller 260 determines that the appliance is not in the descaling mode, the controller 260 may determine a type of the liquid as pure or impure and monitor filter performance accordingly as discussed above.

The controller 260 is further configured to adjust at least one descaling setting of the appliance based on the determined type.

The at least one descaling setting can be selected from a plurality of descaling settings comprising duration of carrying out descaling and temperature during descaling. For example, in response to determining the type of the descaling agent, the controller 260 may adjust either duration of descaling or temperature at which descaling is performed, or both.

In some implementations, if the controller 260 determines that the liquid is a normal concentration descaling agent, the controller 260 may adjust at least one of the temperature and duration associated with descaling proportionate to the determined first ionic content value as discussed below.

If the ionic content value is above the threshold range, i.e. the determined type is a high concentration descaling agent, the controller 260 may cause the user interface of the appliance 100 to indicate to a user to dilute the descaling agent. If the ionic content value is below the threshold range, i.e. the determined type is low concentration descaling agent and the descaling mode is selected by the user, the controller 260 may cause the user interface of the appliance 100 to indicate to a user to add more descaling agent.

During descaling, the controller 260 may be further configured to monitor if descaling has been completed. For example, to determine whether descaling has been completed, the controller may continuously monitor a signal from a first sensor assembly. If no signal is received from the sensor assembly after descaling has commenced (the system effectively becomes an open circuit between 410 and 420), the controller 260 may determine that there is no liquid in the tank and accordingly determine that descaling has completed. Alternatively, upon detecting no liquid in the tank the controller can issue an alert to the user to add water to flush the internal components of the coffee machine and fully complete the cleaning cycle.

In alternative implementations, the controller 260 may monitor, during descaling, a second ionic content value and determine whether descaling of the appliance 100 has been completed based on the second ionic content value. In some implementations, the second ionic content value is determined for the liquid in the same receptacle as the first ionic content value, but at a different time. The second ionic content value may be compared to the first ionic content value, if the second ionic content value does not match the first ionic content value, the controller 260 may determine that descaling has completed. In alternative implementations, the second ionic content value may be compared with an “open circuit” threshold. If the second ionic content value is about or lower than the “open circuit” threshold, the controller 260 may determine that the receptacle does not contain any liquid or descaling agent, i.e. that descaling has been completed. Alternatively, upon detecting no liquid in the tank the controller can issue an alert to the user to add water to flush the internal components of the coffee machine and fully complete the cleaning cycle.

Once the controller 260 determines that descaling has completed, the controller 260 may obtain a further ionic content value near the outlet of the appliance 100 to check if all descaling agent has flushed through the system. For example, the controller 260 may compare the further ionic content value with a stored ionic content value corresponding to water. If the controller 260 determines that the further ionic content value matches the stored ionic content value for water, i.e. less than the second threshold, the controller may indicate to the user that the appliance is ready for further use. Alternatively, the controller 260 may continue flushing water through the appliance until the further ionic content value matches the stored threshold.

In other words, the controller 260 monitors ionic content of liquid during descaling and confirms that the descaling agent has flushed through the appliance. In some implementations, when no descaling agent is detected in the receptacle, the controller 260 may control the appliance to run water through the appliance for certain amount of time to clean through until all residues of the descaling agent have flushed through the appliance.

The proposed descaling approach is particularly advantageous because although periodic descaling is highly recommended, some users do not use a descaling agent and just bypass the descaling process by running with water which could result in damage to the appliance due to scale.

Moreover, descaling a coffee machine with highly concentrated descaling agent could cause to damage silicon tubes, heater etc. Similarly, low concentrated descaling agent could cause incomplete descale process which will result in blocking the appliance. Accordingly, the disclosed arrangements are particularly advantageous to prolong useful life of the appliance, for example, by ensuring that descaling is conducted with appropriate descaling settings for a particular concentration of a descaling agent.

Below provided an example of determining the concentration of the descaling agent and adjusting at least one descaling setting, also referred to as a descaling profile, to provide improved descaling results and/or to inform user if incorrect concentration of the descaling agent is used.

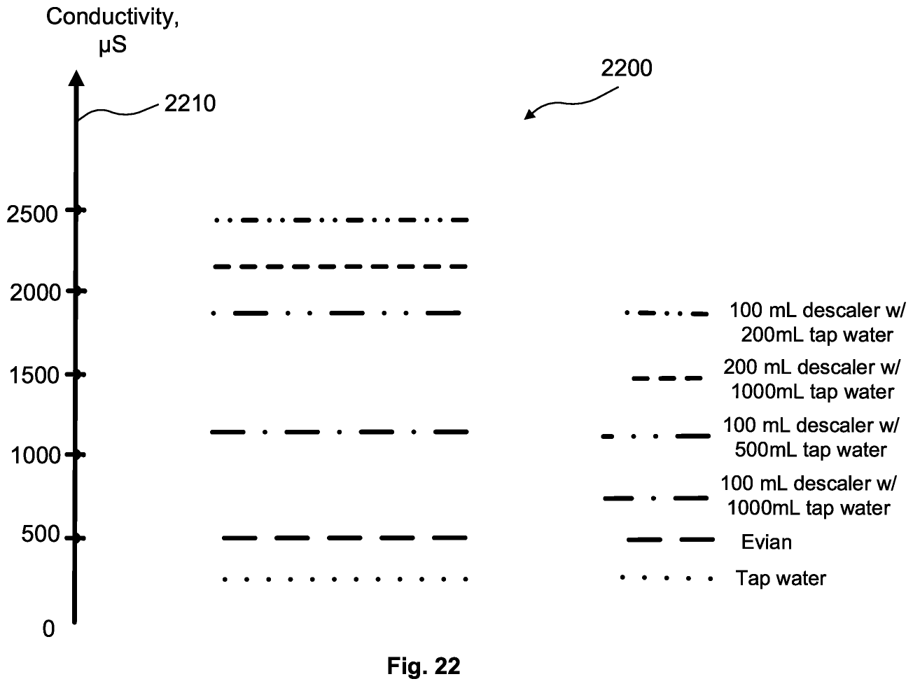

FIG. 22 shows normalised electrical conductivity values 2200 of lower and higher hardness drinking water as well as several types of descaling agent plotted on axis 2210 representing electrical conductivity.

It is noted that an electrical conductivity value of descaling agent is much higher than an electrical conductivity value of drinking water. Accordingly, concentration of the descaling agent (or the type of liquid based on such concentration) can be determined. Also, higher concentration of the descaling agent shows a higher electrical conductivity value which can be mapped with a look up table.

Accordingly, electrical conductivity values of the descaling agent can be determined using direct or indirect electrodes in the appliance 100. The determined electrical conductivity values can be considered to be a function of the concentration of the descaling agent. The descaling profile of the appliance can be adjusted based on the descaling agent concentration measured from the sensor assemblies (electrodes).

If the concentration is below the third threshold, the controller 260 can generate a notification or an alert to the user advising to add more descaling agent to the appliance 100. If the concentration is above the third threshold, the controller can generate a notification or an alert to advise user to dilute the descaling agent.

The notification or the alert can be displayed on a display device of the user interface of the appliance 100. Alternatively, the notification can be delivered by any other means, for example, by playing an audio message to the user or by delivering the notification to user's mobile phone.

Additionally, a further sensor assembly similar to either 109 or 111 can be installed near the outlet of the appliance 100. If the further sensor is installed in a section of the liquid flow path where the temperature is expected to be different to that at sensor assemblies 109 or 111, the measured values may be normalized based on the actual temperature at the further sensor assembly. That further sensor assembly may be used to detect the electrical conductivity value of the liquid from the outlet and determine if the appliance 100 is fully flushed and cleaned before end the process.

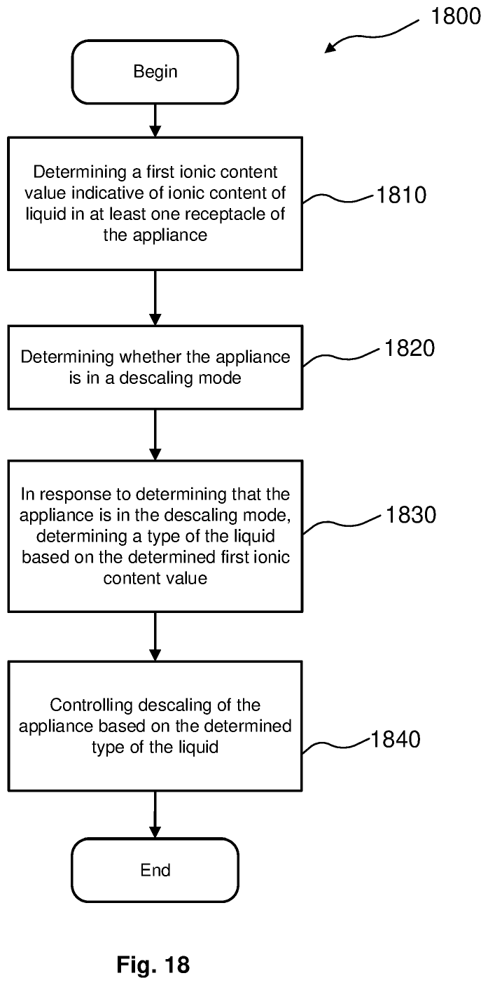

FIG. 18 shows method 1800 of operation of the controller 260 executing instructions stored in memory 309. The method 1800 starts with step 1810 of determining a first ionic content value indicative of ionic content of liquid in at least one receptacle of the appliance 100. As discussed above, the first ionic content value can be determined from the signal received from the sensor assembly 109 or 111.

The method 1800 proceeds from step 1810 to step 1820 of determining whether the appliance 100 is in a descaling mode. The controller 260 can check memory 309 to determine whether a user has selected the descaling mode, whether automatic descaling has been activated or determining if the liquid is the descaling agent based on the first ionic content value. In response to determining that the appliance 100 is in the descaling mode, the method 1800 proceeds to determining in step 1830 a concentration of the descaling agent in the liquid based on the determined first ionic content value.

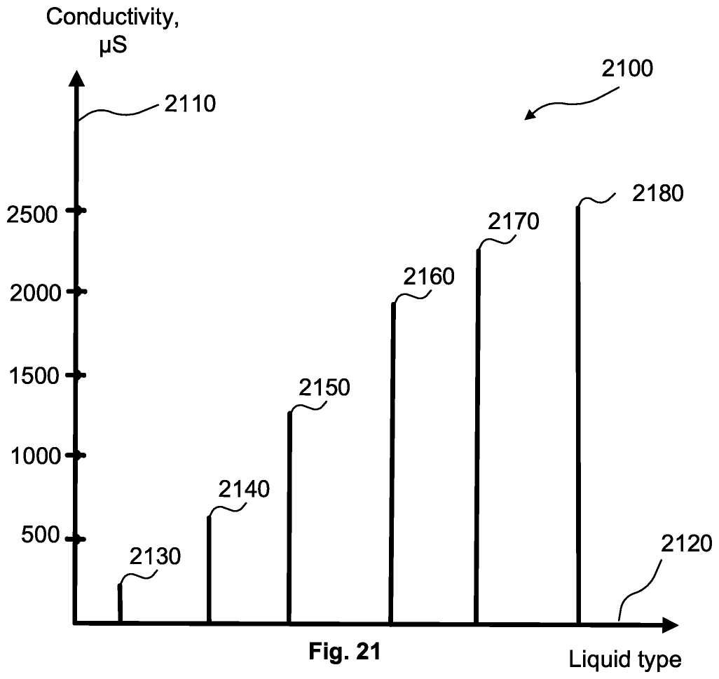

The controller 260 can determine the concentration of the descaling agent based on the first ionic content value, such as an electrical conductivity value or a magnetic permeability value. For the purposes of determining the concentration, the controller 260 may apply calibration discussed in 1230 and normalisation discussed in 1240 when determining the first ionic content value. The concentration of the descaling agent can be determined based on correspondence between ionic content values and concentration values of the descaling agent. The correspondence may be stored as a look-up table in memory 309. Example values for electrical conductivity for different liquids are shown in FIG. 21.

FIG. 21 shows a mapping 2100 between electrical conductivity values 2110 and liquid types 2120. The mapping shows a typical electrical conductivity value 2130 of tap water, typical electrical conductivity value of natural spring water (Evian®) 2140, typical electrical conductivity value of 100 ml descaling agent w/1000 ml tap water 2150, typical electrical conductivity value of 100 ml of a first descaling agent w/500 ml tap water 2160, typical electrical conductivity value of 200 ml of a second descaling agent w/1000 ml tap water 2170 and typical electrical conductivity value of 100 ml descaling agent w/200 ml tap water 2180.

Differences in electrical conductivity values 2160 and 2170 may be caused by different chemical compositions or brands of descaling agents rather than concentration of the descaling agent as such. For the purposes of the present invention, a type of descaling agent is determined, e.g. low concentration, normal concentration and high concentration descaling agent, based on ionic content rather than concentration of a descaling agent as such, which may vary amongst different brands. The mapping 2100 is shown for illustrative purposes only. Specific threshold values for determining a type of a descaling agent are programmed into the controller 260 regardless of the brand of the descaling agent. Since the type of a descaling agent is determined largely based on ionic content values, the proposed approach is found to work well regardless of different brands or chemical compositions of descaling agents.

Once the concentration of the descaling agent is determined at step 1830, the method 1800 proceeds to controlling 1840 descaling of the appliance 100 by adjusting at least one descaling setting of the appliance based on the determined concentration. The method 1800 concludes in response to completion of step 1840.

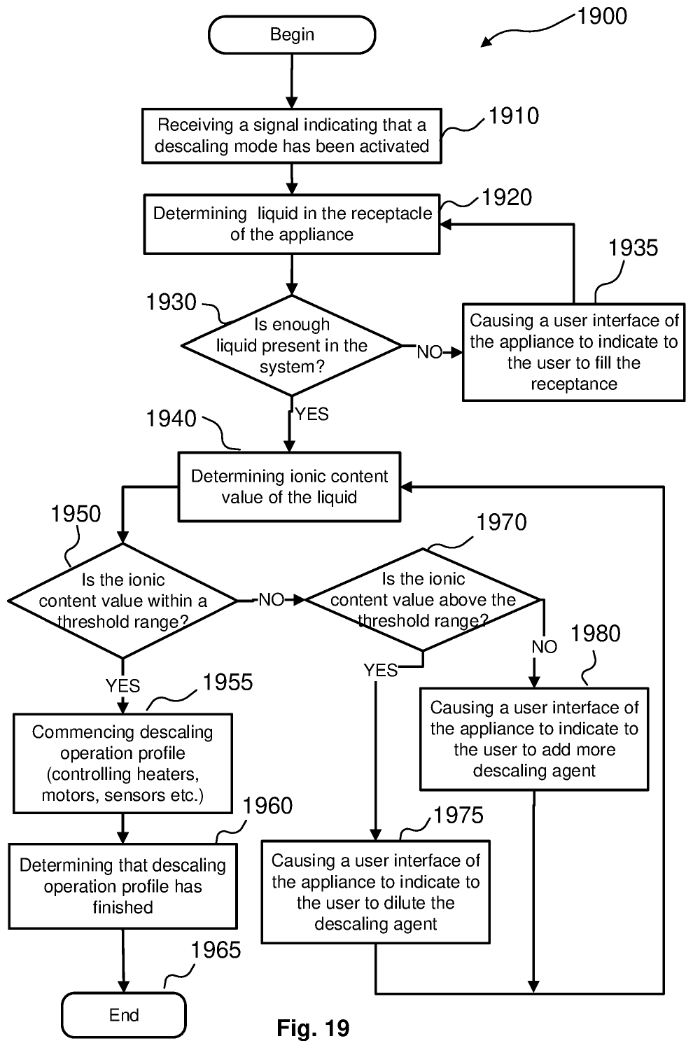

FIG. 19 shows a method 1900 of controlling descaling process. The method is executed by the controller 260 under control of instructions stored in memory 309. The method 1900 starts at a step 1910 of receiving a signal indicating that a descaling mode has been activated. For example, the signal may be received in response to activating a descaling mode. The descaling mode may be activated manually by the user or automatically, for example, based on a timer setup for the appliance 100.

Step 1910 proceeds to a step 1920 of determining liquid in the receptacle of the appliance. The controller 260 executing instructions stored in memory is configured to receive a signal from the sensor assembly. The controller 260 is configured to determine the liquid based on the signal from the sensor assembly. For example, the controller 260 may determine presence of the liquid in the receptacle. Alternatively, the controller 260 may determine a level of the liquid in the receptacle.

The method 1900 proceeds from step 1920 to step 1930 to determine whether enough liquid is present in the system to run a complete cycle of a descaling profile selected by the user.

In some implementations, the controller 260 checks the level of the liquid in the receptance against a threshold stored for the selected descaling profile. Alternatively, the controller 260 determines if the liquid is present in the receptacle. For example, the controller 260 may determine whether any signal is received from the sensor assembly after the descaling mode has been activated. If no signal is received, the controller 260 at step 1920 determines that there is no liquid in the receptacle, i.e. “No” at step 1930.

In alternative implementations, the controller 260 may monitor the first ionic content value and determine whether there is enough liquid based on the first ionic content value. In some implementations, the first ionic content value may be compared with the “open circuit” threshold. If the first ionic content value is about or lower than the “open circuit” threshold, the controller 260 may determine that the receptacle does not contain any fluid or descaling agent, i.e. “No” at step 1930.

If not enough liquid is detected at step 1930, the method 1900 proceeds to a step 1935 of causing a user interface of the appliance to indicate to the user to fill the receptance, e.g. the tank 102. The method 1900 continues from step 1935 to step 1920.

Alternatively, if enough liquid is detected at step 1930, the method 1900 proceeds to a step 1940 of determining ionic content value of the liquid. The ionic content value may be determined in a similar manner as discussed above. Step 1940 proceeds to a step 1950 of determining whether the ionic content value is within a threshold range stored in memory 309.

The threshold range defines a normal (or baseline) concentration descaling agent. In one implementation, the threshold range can be pre-programmed to be between the first threshold (1000 μS/cm) and the second threshold (2000 μS/cm). In alternative implementations, the thresholds range can be selected by the user.

If the ionic content value is determined to be within the threshold range at step 1950, the method 1900 proceeds to a step 1955 of commencing descaling operation profile by controlling heaters, motors, sensors etc. Otherwise the method 1900 proceeds to a step 1970 of determining whether the ionic content value is above the threshold range.

At step 1955, the controller 260 controls the appliance to commence the selected descaling operation profile. Additionally, the controller 260 controls the heater, the motor and the sensors of the appliance in accordance with the selected descaling profile and the ionic content value determined at step 1940. For example, the controller 260 may adjust temperature and duration of descaling proportionate to the determined ionic content value. For example, the descaling profile may have an allowable range of working temperatures and durations, the allowable range may be mapped to the threshold range to determine how the temperature and/or duration are to be adjusted. Furthermore, at step 1955 the controller may alert the user, after one of the operation profiles has finished, to add water into the system to flush out any residual chemical components that may have been left over.

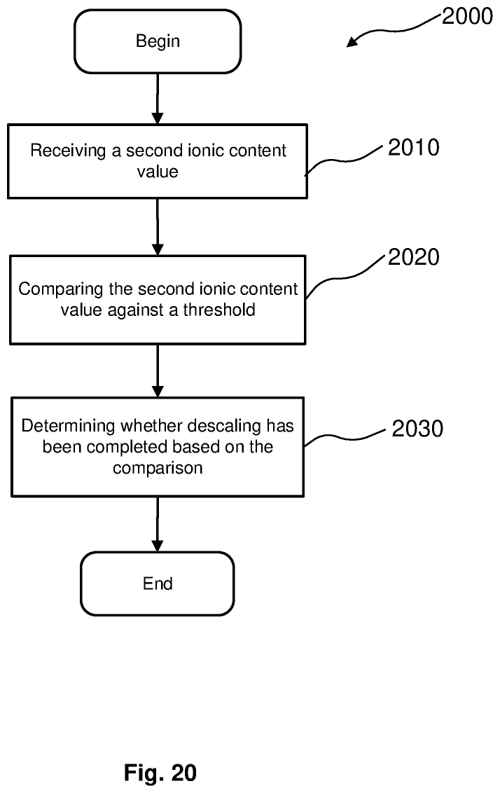

Step 1955 continues to a step 1960 of monitoring descaling and determining whether the descaling operation profile has finished. For example, the controller at step 1960 may detect if there is any liquid left in the receptacle using any of the methods discussed above. If no liquid is left, the controller 260 determines that the descaling operation profile has finished, for example, as shown in FIG. 20. In response to determining that the descaling operation profile has finished, the controller 260 may control the appliance to run water for a certain amount of time so that all descaling agent is flushed through the appliance 100. Alternatively, the controller 260 may be configured to run water through the appliance until a further ionic content value at the outlet of the appliance matches the ionic content value for tap or pure water. The method 1900 concludes 1965 at completion of step 1960.

Returning back to step 1950, if the ionic content value is determined to be outside of the threshold range, the method 1900 proceeds to step 1970. At step 1970, if the ionic content value is determined to be above the threshold range, the method 1900 proceeds to a step 1975 of causing a user interface of the appliance 100 to indicate to the user to dilute the descaling agent. Otherwise, the method 1900 proceeds to step 1980 of causing a user interface of the appliance 100 to indicate to the user to add more descaling agent. The method 1900 continues from steps 1975 and 1980 to step 1940.

FIG. 20 shows a method 2000 of determining if descaling has been completed. The method 2000 is executed by the controller 260 under control of instructions stored in memory 309. The method 2000 starts at step 2010 of receiving a further ionic content value. The further ionic content value can be determined in the same receptacle as the first ionic content value or in a different receptacle.

Step 2010 proceeds to step 2020 of comparing the further ionic content value against a threshold. In some implementations, the threshold may correspond to conductivity detected in an empty receptance. Alternatively, the threshold may correspond to the first ionic content value or an ionic content value of tap or pure water depending on an implementation.

The method proceeds from step 2020 to step 2030 of determining whether descaling has been completed based on the comparison. For example, if the further ionic content value satisfies the threshold for an empty receptacle, the first ionic content value or the ionic content value for tap or pure water, the controller 260 may determine that descaling has completed. The method 2000 concludes on completion of step 2030.

### EXAMPLES

FIG. 23 shows an example configuration 2300 of an appliance with a removable tank. The appliance has a removable tank 2310 (similar to the tank 102) that is mountable onto a supporting base portion 2320 of the appliance 100. The supporting base portion 2320 has a platform portion on which the removable tank 2310 is locatable and a rear wall portion extending upwardly from the platform portion. The platform portion includes a hydraulic connector 2340 and a pogo pin assembly 2350. The pogo pin assembly 2350 is interactable with probe assembly located on an underside of the tank 2310. When the tank 2310 is mounted on the platform portion of the base portion 2320, the rear wall portion of the base portion 2320 touches a rear wall of the tank 2310. The rear wall portion has a pair of spaced apart locator portions 2330 that are cooperable with respective channel portions in a rear wall of the removable tank 2310. In another example, the rear wall portion has one locator portion or more than two locator portions. In yet another example, the rear wall portion has one or more channel portions that are cooperable with respective one or more locator portions in a rear wall of the removable tank. The locator portions 2330 on the rear wall are protrusions for securely locating the tank 2310 onto the platform portion to align the tank 2310 with the hydraulic connector 2340 and connectors of the pogo pin assembly 2350. Each locator portion 2330 has a tapered profile-a width of the locator portion closer to the platform portion being larger than a width of the locator portion further away from the platform portion. The removable tank 2310 slides along the rear wall portion of the base portion 2320, as guided by the engagement of the locator portions 2330 on the rear wall with the respective channel portions of the removable tank 2310.

As previously described, the supporting base portion 2320 comprises the pogo pin assembly 2350 and the hydraulic connector 2340. The supporting base portion 2320 is configured to receive treated or untreated liquid depending on a specific configuration of the appliance.

The hydraulic connector 2340 couples the tank 2310 with hydraulics of the appliance, e.g. the liquid flow path, to facilitate liquid communication between the removable tank 2310 and the appliance. The removable tank 2310 has a mouth portion (or opening) on a bottom wall thereof that is communicable with the hydraulic connector 2310. In some implementations, the hydraulic connector 2340 may include a seal for sealing the communication with the mouth portion of the removable tank 2310.

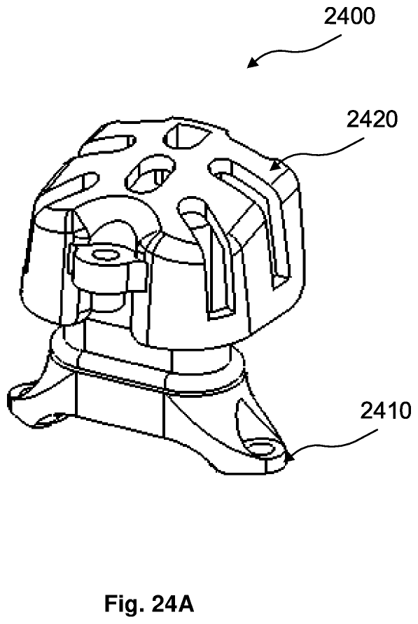

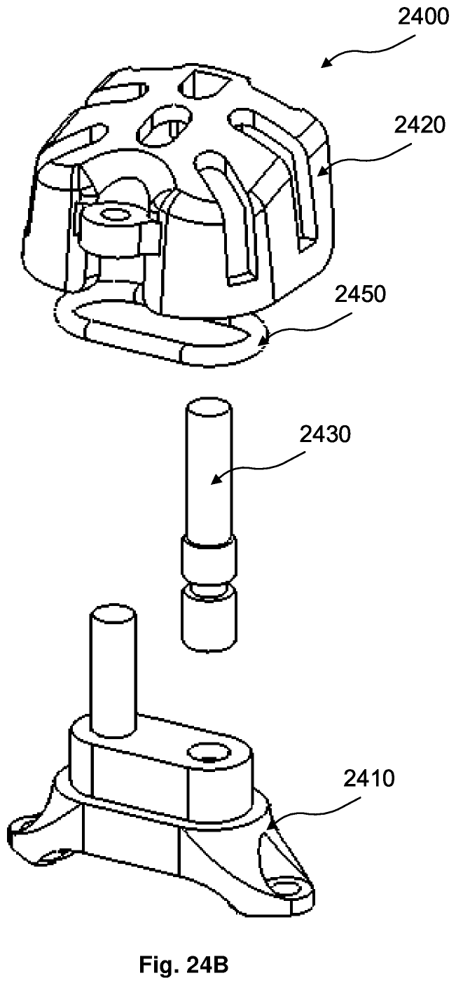

The pogo pin assembly 2350 is configured to engage with a probe assembly (not shown) to generate an electrical signal to the controller indicating a degree of purity of the untreated liquid in the tank 2310. The pogo pin assembly and the probe assembly collectively form the first sensor assembly in accordance with one implementation of the present disclosure. The configuration of the pogo pin assembly and the probe assembly is discussed in more detail more with references to FIGS. 24A-30B.

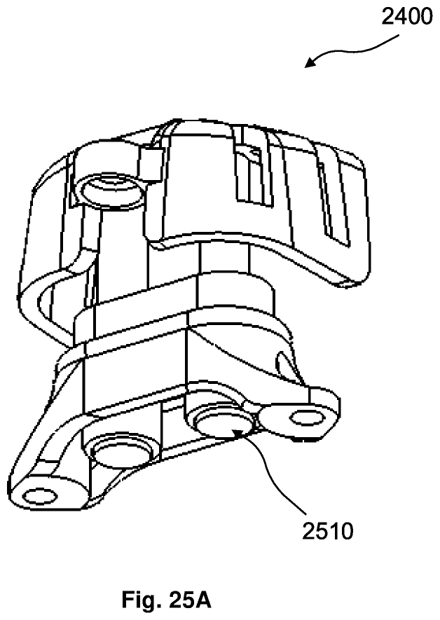

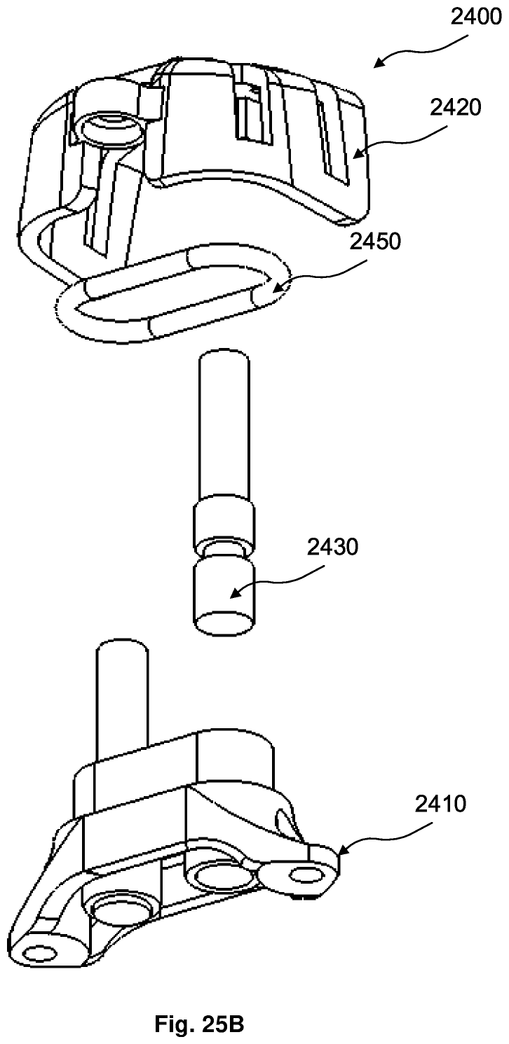

The probe assembly is discussed below with references to FIGS. 24A to 25B. FIG. 24A shows a front perspective view of the probe assembly 2400. FIG. 24B shows an exploded front perspective view of the probe assembly 2400. FIG. 25A shows a bottom perspective view of the probe assembly 2400 and FIG. 25B shows an exploded bottom perspective view of the probe assembly 2400.

The probe assembly 2400 comprises a probe body 2410, probes 2430, a seal 2450 and a protective cap 2420. The probe body 2410 acts as a mounting bracket for the probes 2430. In particular, the probe body 2410 has a pair of spaced apart recesses for receiving respective probes 2430. In some implementations, the probes 2430 are electrodes configured to send pulses and receive pulses to measure conductivity of the liquid in the tank 2310. Additionally or alternatively, the probes are configured to detect water presence in the tank based on an electric conductivity determined based on measurements by the probes. The cap 2420 is configured to cover the probes 2430 in the probe body 2410 to prevent access, tampering, and/or damage to the probes, such as accidental damage to the probes 2430 by the user when the tank is removed from the base portion for example. The seal 2450 is configured to provide a seal interface between tank 2310 and the probe assembly 2400. When installed, the cap 2420 and portions of the probes 2430 that are protected by the cap 2420 are located inside the tank. In another embodiment, the probe assembly comprises a probe body and probes, and the tank comprises the cap for protecting the portions of the probe that are located inside the tank. In this embodiment, the probe assembly can be removed from the tank and replaced.

The probe assembly 2400 is used to measure conductivity of the liquid in the tank 2310 as a measure of total dissolved solids (TDS) to determine purity or hardness of the untreated liquid in the tank 2310. The probe assembly 2400 is electrically coupled with the controller 260 via the pogo pin assembly 2350 to communicate the electrical signal indicating the measured conductivity to the controller 260. For example, the probes 2430 each have a bottom portion 2510 which comes into contact with a respective pogo pin to send pulses and receive pulses to measure water conductivity and interface with the internal electronics of the appliance 100, for example, the controller 260. The bottom portion 2510 of each probe 2430 includes an exposed electrical contact that is contactable by a respective pogo pin. As discussed above, the controller 260 powers the electrodes of the probe assembly 2400, for example, via the pogo pin assembly 2350. The controller 260 also determines purity or hardness of the untreated liquid in the tank 2310 based on the electrical signal from the probe assembly 2400. In the embodiment shown in the figures, the probes 2430 are fixed in the probe body 2410. The probe body 2410 electrically isolates the probes 2430 from each other. In other embodiments, the probes are spring-loaded probes that are retractably extendable from the probe body to provide a solid electrical contact with the pins of the pogo pin assembly.

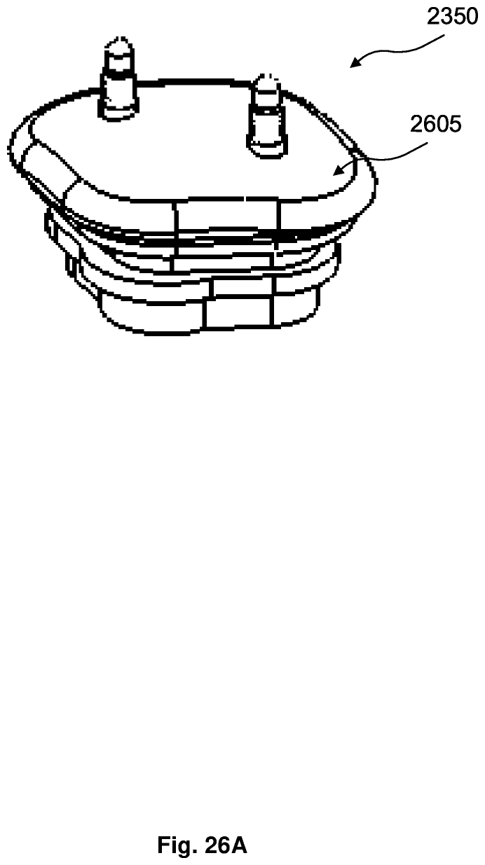

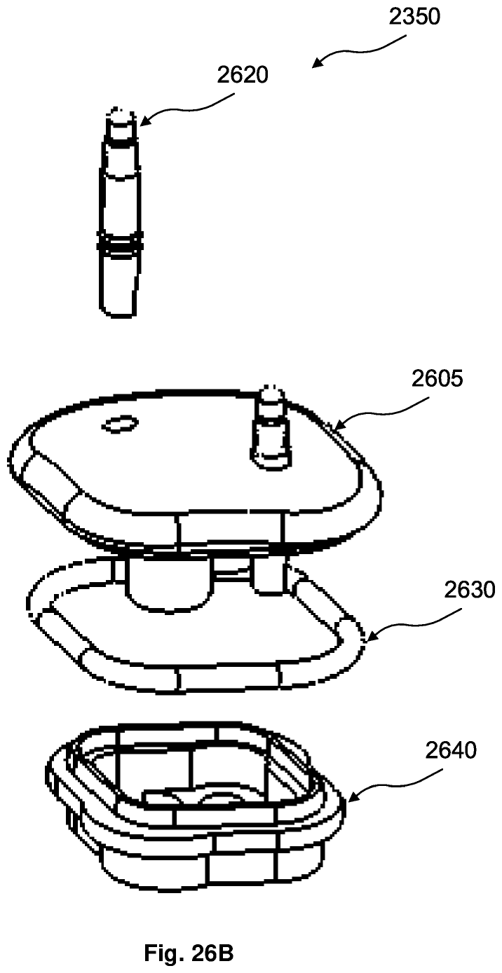

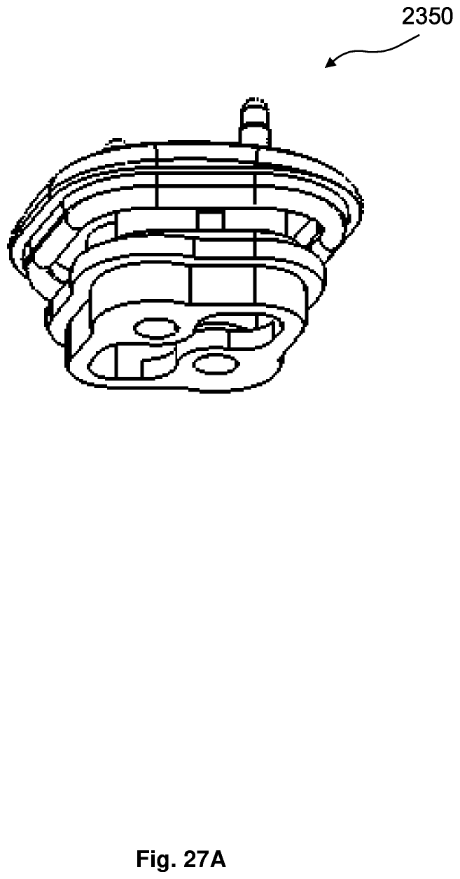

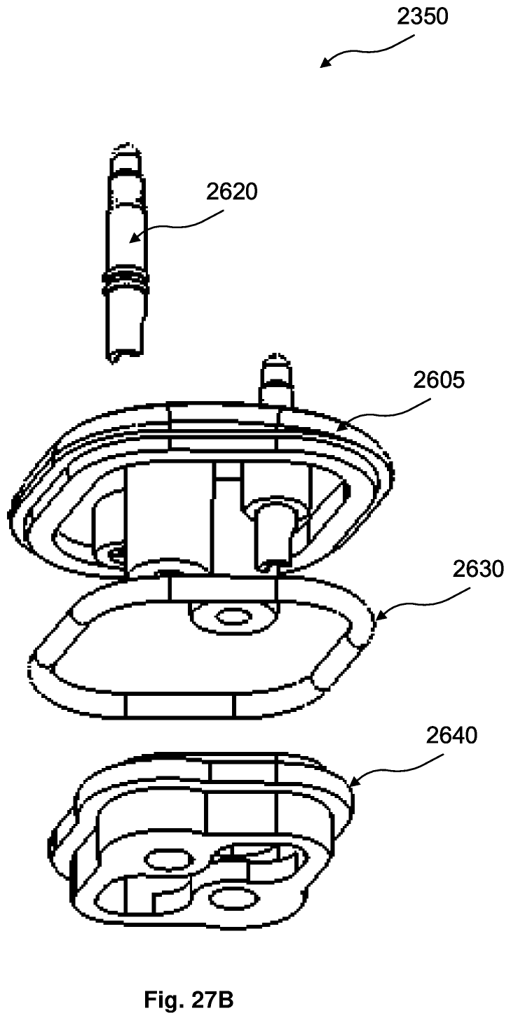

FIGS. 26A and 26B show a front perspective view and an exploded front perspective view respectively of the pogo pin assembly 2350. FIGS. 27A and 27B show a bottom perspective view and an exploded bottom perspective view of the pogo pin assembly 2350.

The pogo pin assembly 2350 comprises a pogo pin body 2605, pogo pins 2620, a pogo pin seal 2630 and a seal bracket 2640. The pogo pin body 2605 holds the pogo pins 2620 to be in contact with the bottom portion 2510 of the probes 2430. The pogo pins 2620 are spring loaded pins configured to transfer the conductivity signal from the probes to the controller 260. The spring-loaded pins are particularly advantageous to allow the tank 2310 to be removed and put back in place without cables, however, alternative configurations of the pins are also possible.

The pogo pin seal 2630 extends along the circumference of the pogo pin body 2605 to ensure that any spillage on the pogo pin assembly does not result in water ingress inside the appliance 100. The seal bracket 2640 is configured to sandwich the pogo pin body 2605 and seal 2630 against a panel of the supporting base portion 2320, for example, the rear panel. The seal bracket 2640 is particularly advantageous when there are constraints on rear panel modification of the tank 2310.

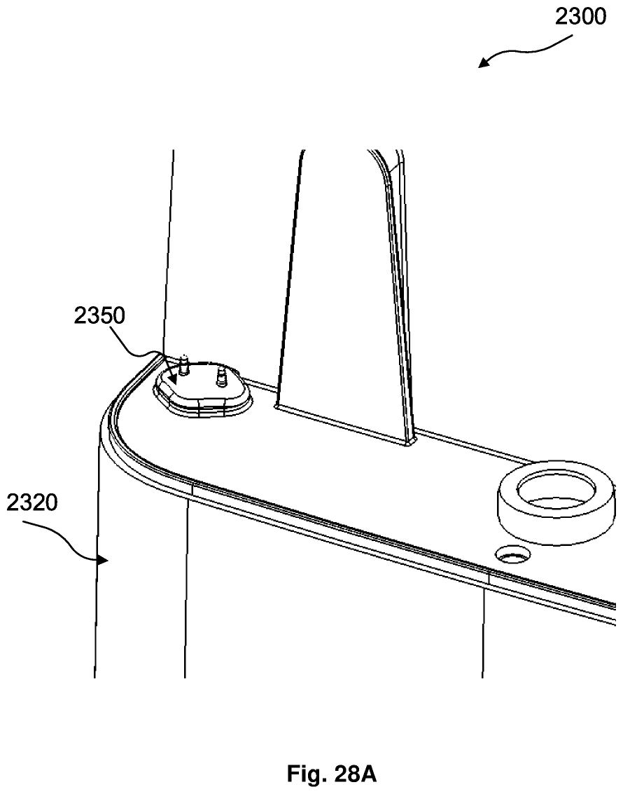

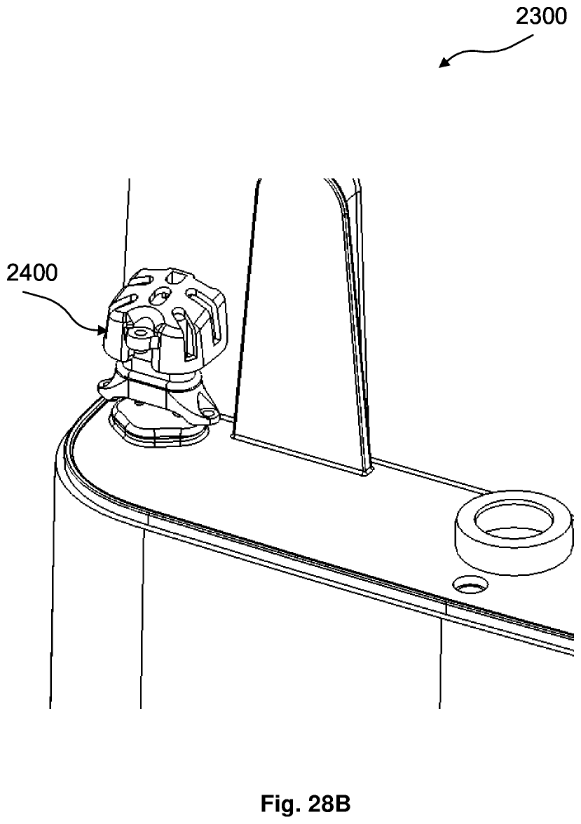

FIG. 28A depicts an enlarged view of the pogo pin assembly 2350 mounted within the supporting base portion 2320. FIG. 28B demonstrates an enlarged view of the probe assembly 2400 mounted onto the pogo pin assembly 2350 collectively forming the first sensor assembly 2830.

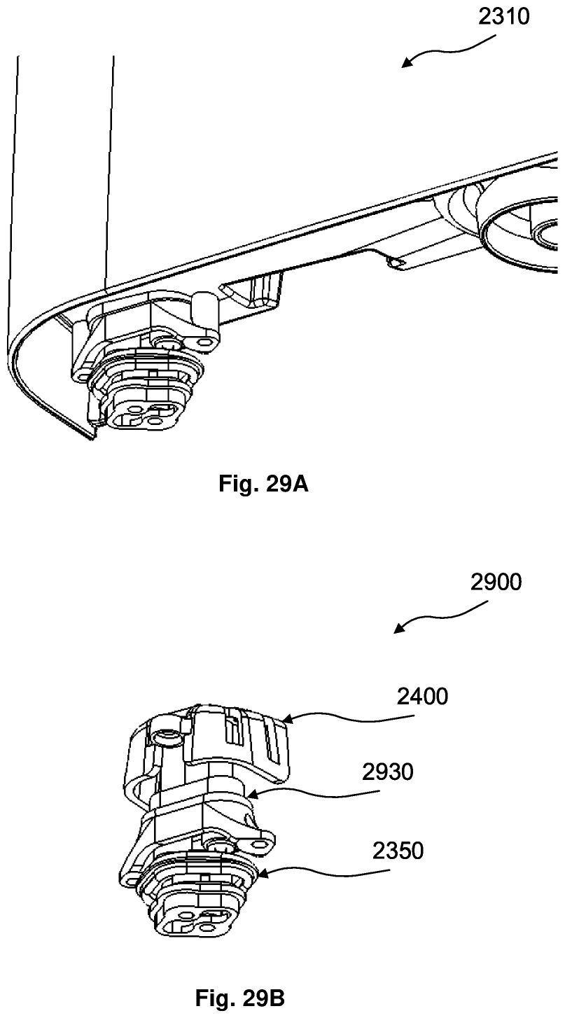

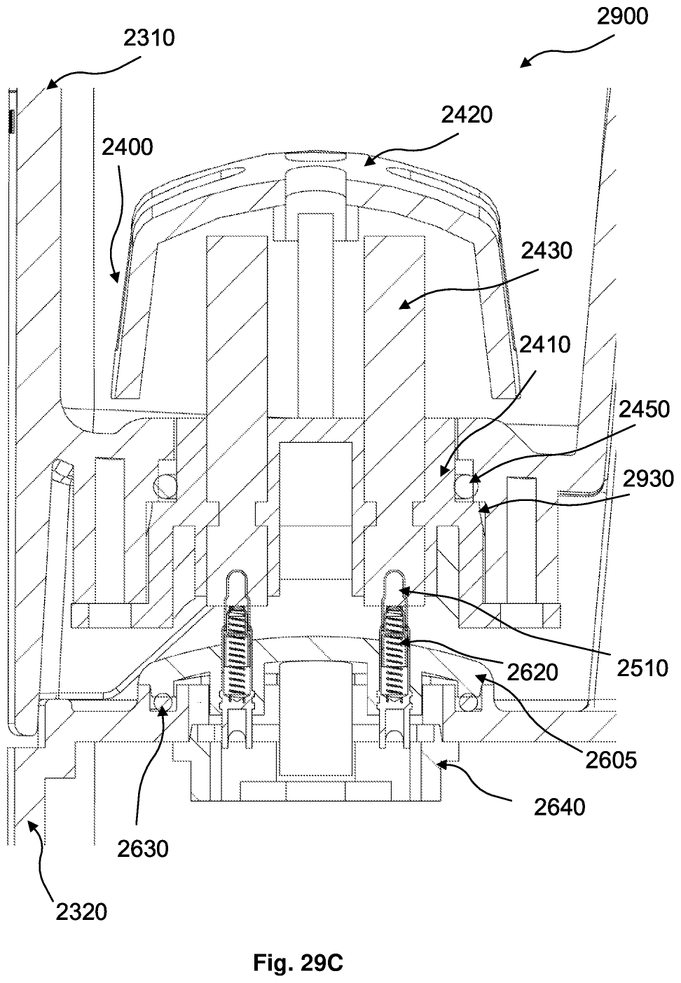

FIG. 29A shows an enlarged perspective view of the first sensor assembly formed by the probe assembly 2400 and the pogo pin assembly 2350 mounted at a bottom portion of the tank 2310. The first sensor assembly is mounted to the tank 2310 so that a distal end of the probes 2430 are in contact with the liquid in the tank 2310 and a proximal end of the probes 2430, i.e. the bottom portion 2510, is in contact with the pogo pins 2620.

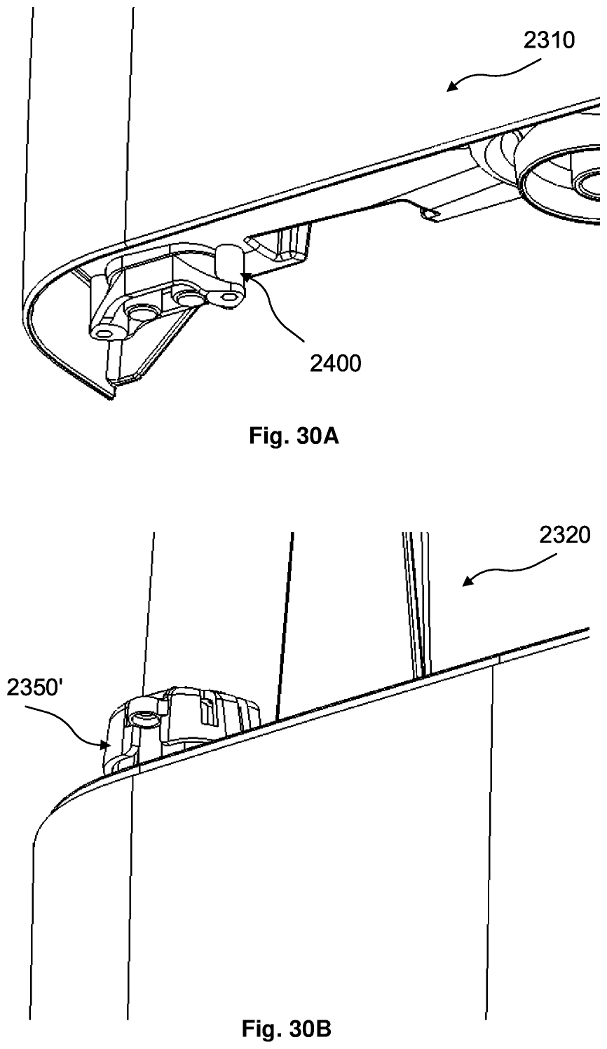

FIG. 29B shows a perspective view of the first sensor assembly 2900 formed by the probe assembly 2400 and the pogo pin assembly 2350 and FIG. 29C shows a sectional view of the first sensor assembly 2900. As shown in FIG. 29B, the probe body 2410 of the probe assembly 2400 comprises a shoulder 2930 transversely extending around a portion of the probe body 2410 supporting the probes 2430. The shoulder 2930 acts as a stopper to prevent the probe assembly 2400 from sliding into the tank 2310 entirely. As shown in FIG. 29C, the bottom portions 2510 of the respective probes 2430 of the probe assembly 2400 contact the pogo pins 2620 of the pogo pin assembly 2350. The pogo pins 2350 are biased away from the pogo pin body 2605 to thereby create a solid electrical contact with bottom portions 2510 of the respective probes 2430. Portions of the probes 2430 and the protective cap 2420 that covers those probe portions are located inside the tank 2310, the probes 2430 being configured to measure electrical conductivity of the liquid in the tank 2310. The pogo pin body 2605 and the seal bracket 2640 engage each other to clamp onto the wall portion of the base portion 2320 to thereby sandwich the seal 2630 and prevent water ingress into the base portion 2320. The wall portion of the base portion 2320 has an annular channel in which the seal 2630 is received. An underside of the pogo pin body 2605 has an annular projection that is receivable by the annular channel to compress the seal in the channel of the base portion 2320. The probe body 2410 with the probe portions previously described is insertable in an aperture (or opening) in a bottom wall of the tank 2310 to thereby locate the probe portions in the tank 2310. The seal 2450 surrounds the probe body 2410 to prevent liquid from escaping the tank 2310 via the aperture. The seal 2450 rests on the shoulder 2930 of the probe assembly 2400. When the probe body 2410 is secured to the tank 2320 a space is defined between the shoulder 2930 and a portion of the bottom wall of the tank 2310 surrounding the aperture. The seal 2450 is located in the space between the shoulder 2930 and the portion surrounding the aperture. FIG. 30A demonstrates an enlarged perspective view of the probe assembly 2400 positioned within the tank 2310. FIG. 30B shows an enlarged perspective view of the pogo pin assembly 2350′ with a protective cap similar to the protective cap 2420.

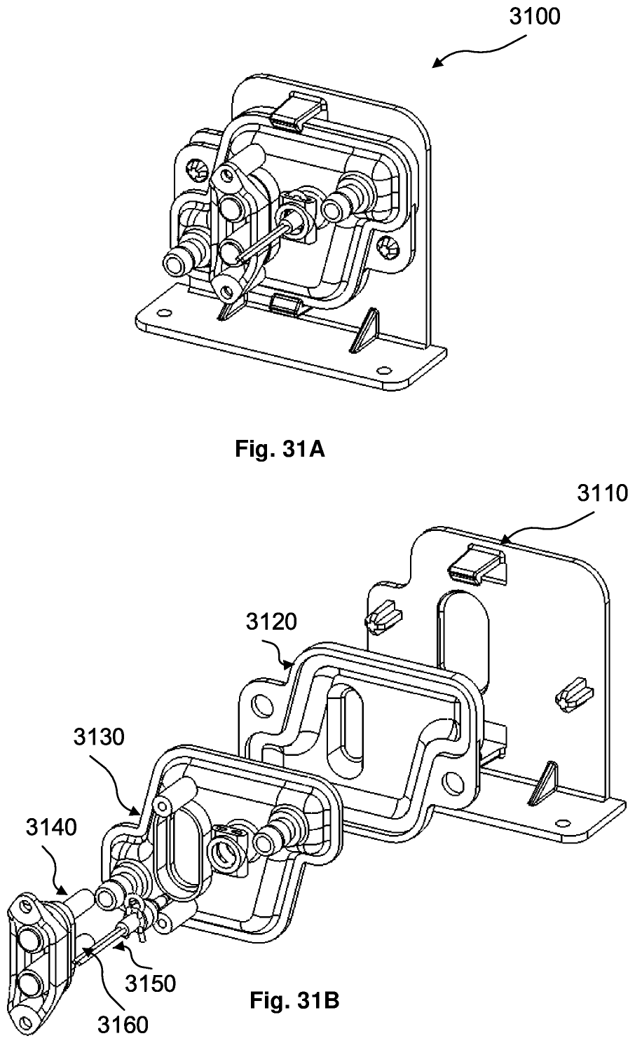

FIGS. 31A, 32A and 33A show a right perspective view, a left perspective view and a rear perspective view respectively of the second sensor assembly 250 in accordance with one implementation of the present disclosure. FIGS. 31B, 32B and 33B show an exploded right perspective view, an exploded left perspective view and an exploded rear perspective view respectively of the second sensor assembly 250 in accordance with one implementation of the present disclosure. In some implementations, the second sensor assembly 250 is an inline sensor assembly 3100, i.e. a sensor assembly installed within a hydraulic line or the liquid flow path of the appliance 100.

The inline sensor assembly 3100 may be an in-line hard water detection (HWD) sensor assembly which measures conductivity of the liquid within the hydraulic line of the appliance 100. The sensor assembly 3100 comprises a bracket 3110, a bottom cover 3120, a top cover 3130, a probe assembly 3140 and a temperature sensor 3150, e.g. NTC, mounted on the top cover 3130.

The bracket 3110 comprises a supporting base plate and a transverse plate extending away from the base plate along the longitudinal axis of the base plate. The bracket 3110 also comprises an opening, for example in the transverse plate, for receiving probes of the probe assembly 3140 and a plurality of protrusions to hold the in-line sensor assembly 3100 in various orientations to suit different appliances and different placements. Specifically, the transverse plate is configured to receive the probes in the opening and hold the probe assembly 3140 in a required orientation using the protrusions.

The bottom cover 3120 is configured to assemble with the top cover 3130 to form a flow channel for receiving the probes. The flow channel is configured so that air bubbles float out to the outlet of the channel to allow correct measurement of the conductivity. The top cover 3130 is configured to hold the probe assembly 3140 and the NTC 3150.

The probe assembly comprises probes 3160. Each probe 3160 comprises wires welded to a proximal end of the probe 3160 to connect to the controller 260. Due to potential presence of solids in the liquid, an electrical signal generated by the sensor assembly 3100 corresponds to resistance or conductivity of the liquid 3160 in the liquid flow path between distal ends of the probes 3160. As discussed above, the controller 260 uses the electrical signal to determine a degree of purity which corresponds to the TDS and/or hardness of the liquid.

### INDUSTRIAL APPLICABILITY

The arrangements described are applicable to the industry of manufacturing and maintaining appliances for making beverages and particularly for monitoring performance of a filter assembly within the appliance for making a beverage.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. An appliance for making a beverage, the appliance comprising:
at least one beverage making component configured to receive liquid for making the beverage using liquid;
a liquid flow path in fluid communication with and configured to provide the liquid to the at least one beverage making component, the liquid flow path comprising:
an inlet configured to receive untreated liquid, the inlet comprising a first sensor assembly configured to generate a first electrical signal indicative of a degree of purity of the untreated liquid,
a filter assembly positioned between the inlet and the at least one beverage making component and configured to filter the untreated liquid; and
a second sensor assembly positioned between the filter assembly and the at least one beverage making component to generate a second electrical signal indicative of a degree of purity of the treaded liquid; and
a controller coupled with the first sensor assembly and the second sensor assembly and configured to monitor a performance of the filter assembly based on the first electrical signal and the second electrical signal.

2. The appliance according to claim 1, wherein the controller is further configured to determine an electrical conductivity of the untreated liquid based on the first electrical signal and determine an electrical conductivity of the treated liquid from the filter assembly based on the second signal.

3. The appliance according to claim 2, wherein each of the first sensor assembly and the second sensor assembly comprises a first electrode and a second electrode, the first electrode and the second electrode being spaced apart from each other.

4. The appliance according to claim 3, wherein the controller is configured to cause the first electrode to have a higher electrical potential than the second electrode for a first set of one or more cycles and cause the second electrode to have a higher electrical potential than the first electrode for a second set of one or more cycles.

5. The appliance according to claim 3, wherein the first electrode and the second electrode of each sensor assembly are configured to be alternately powered by the controller such that one of the electrodes receives voltage from the controller and the other electrode is grounded, wherein the controller is configured to reverse polarity of the electrodes after one or more cycles of determining the electrical conductivity.

6. The appliance according to claim 3, wherein the first electrical signal is detected at the first electrode of the first sensor assembly, and the second electrical signal is be detected at the first electrode of the second sensor assembly.

7. The appliance according to claim 6, wherein the first electrical signal corresponds to a voltage across on the first and second electrodes of the first sensor assembly; and the second electrical signal corresponds to a voltage detected across the first and second electrodes of the second sensor assembly.

8. The appliance according to claim 7, wherein the controller is further configured to:
determine the electrical conductivity of the untreated liquid based on the voltage detected by the first sensor assembly and a configuration of the first electrode and the second electrode of the first sensor assembly; and
determine the electrical conductivity of the treated liquid based on the voltage detected by the second sensor assembly and a configuration of the first and the second electrode of the second sensor assembly.

9. The appliance according to claim 8, wherein the configuration of the electrodes comprises at least one of shape of the electrodes, dimensions of the electrodes, and distance between the electrodes.

10-16. (canceled)

17. A method of controlling an appliance for making a beverage having at least one beverage making component using liquid for making the beverage, a liquid flow path integrally formed with and providing the liquid to the at least one beverage making component and a filter assembly configured for the appliance and filtering the liquid in the liquid flow path, the method comprising:
determining a first electrical signal indicative of a degree of purity of untreated liquid in the liquid flow path;
determining a second electrical signal indicative of a degree of purity of treated liquid in the liquid flow path, the treated liquid being provided to the at least one beverage making component; and
monitoring performance of the filter assembly based on the first electrical signal and the second electrical signal.

18. The method according to claim 17, further comprising:
determining an electrical conductivity of the untreated liquid based on the first electrical signal and a configuration of a sensor assembly generating the first electrical signal; and
determining an electrical conductivity of the treated liquid based on the second signal and a configuration of a sensor assembly generating the second electrical signal.

19-31. (canceled)

32. An appliance for making a beverage, the appliance comprising:
at least one receptacle configured to receive liquid;
a sensor assembly configured to generate an electrical signal indicative of ionic content of the liquid in the receptacle; and
a controller coupled with the sensor assembly and configured to control descaling of the appliance, wherein the controller is configured to:
determine a first ionic content value indicative of ionic content of the liquid in the at least one receptacle of the appliance based on the generated electrical signal;
determine whether the appliance is in a descaling mode;
in response to determining that the appliance is in the descaling mode, determine a type of a descaling agent based on the determined first ionic content value; and
control descaling of the appliance based on the determined type of the liquid.

33. The appliance according to claim 32, wherein the first ionic content value corresponds to at least one of an electrical conductivity value and a magnetic permeability value.

34. The appliance according to claim 32, wherein the controller is further configured to select one of a plurality of descaling settings of the appliance in response to the first ionic content value, each setting of the plurality of descaling settings comprising a respective duration of carrying out descaling and temperature during descaling.

35. The appliance according to claim 34, wherein the controller is configured to increase at least one of the temperature during descaling and the duration of descaling.

36. The appliance according to claim 34, wherein the controller is configured to decrease at least one of the temperature during descaling and the duration of descaling.

37. The appliance according to claim 32, further comprising a user interface, wherein the controller is further configured to cause the user interface to provide an indication to the user to adjust the descaling agent in response to a detected concentration of the descaling agent, wherein the controller is configured to provide an indication to the user to dilute the descaling agent in response to a high concentration of descaling agent being detected; and to provide an indication to the user to add more descaling agent in response to a low concentration of descaling agent being detected.

38. The appliance according to claim 32, wherein the controller is further configured to:
determine a further ionic content value indicative of ionic content of liquid used in the appliance; and
determine whether descaling of the appliance has been completed based on the further ionic content value.

39. The appliance according to claim 38, wherein the controller is configured to determine further ionic content value in the receptacle, wherein the first and further ionic content values are determined by the controller at different times.

40. The appliance according to claim 38, wherein the controller is configured to determine the further ionic content value in at least one further receptacle of the appliance.

41-50. (canceled)
